(19) United States
(12) Patent Application Publication
(10) Pub. No.: US 2006/0057358 A1
(43) Pub. Date: Mar. 16, 2006

(54) Electrophotographic image-receiving sheet and image-forming method using the same

(75) Inventor: Kazuhito Miyake, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJI PHOTO FILM CO., LTD., Minami-Ashigara-shi (JP)

(21) Appl. No.: 11/222,232

(22) Filed: Sep. 9, 2005

(30) Foreign Application Priority Data
Sep. 10, 2004 (JP) 2004-264545

(51) Int. Cl. G03G 15/20; G03G 13/20; B32B 3/00; B32B 23/08

(52) U.S. Cl. 428/313.3; 430/124; 428/509

(57) ABSTRACT

It is an object of the present invention to provide an electrophotographic image-receiving sheet excellent in both adhesion resistance and cracking resistance, and an image-forming method using the electrophotographic image-receiving sheet. Accordingly, the electrophotographic image-receiving sheet contains a support, and at least two polymer layers disposed on the support, and at least one of the polymer layers containing voids.

### BACKGROUND OF THE INVENTION

1. Field of the Invention

The present invention relates to electrophotographic image-receiving sheets which are excellent in both image fixing properties and cracking resistance, and image-forming methods by using the electrophotographic image-receiving sheets.

2. Description of the Related Art

In Japanese patent Application Laid-Open (JP-A) No. 2003-322993, an addition of particles having voids to a toner image-receiving layer is proposed in order to improve heat accumulation properties of electrophotographic image-receiving sheets. According to the proposal, adding the particles having voids to the toner image-receiving layer may improve the image fixing properties.

However, the addition of excessive amount of the particles having voids in the electrophotographic image-receiving sheets may cause crack on the surface of the toner images, when the electrophotographic image-receiving sheets are lifted or inserted in an album. Namely, the excessive addition of particles having voids may adversely affect the handling of electrophotographic image-receiving sheets.

Therefore, it has been desired to be provided promptly that an electrophotographic image-receiving sheet having excellent image fixing properties and superior cracking resistance, and providing high quality images.

### SUMMARY OF THE INVENTION

Accordingly, it is an object of the present invention to provide an electrophotographic image-receiving sheet having excellent image fixing properties and superior cracking resistance, and providing high quality images, and an image-forming method by using the electrophotographic image-receiving sheet.

The electrophotographic image-receiving sheet comprises a support, and at least two polymer layers disposed on the support, wherein at least one of the polymer layers having voids.

According to the present invention, it is possible to obtain the electrophotographic image-receiving sheet having excellent image fixing properties and cracking resistance, and providing high quality images since at least one of the polymer layers have voids.

The image-forming method according to the present invention comprises a toner image-forming step forming a toner image on the electrophotographic image-receiving sheet according to the present invention, and a step for fixing the toner image on the electrophotographic image-receiving sheet, followed by smoothing the surface of the toner image formed by the toner image-forming step.

In the image-forming method according to the present invention, the electrophotographic image-receiving sheet according to the present invention enables to obtain high quality image similar to that of a silver salt photography print efficiently by a simple treatment.

### BRIEF DESCRIPTION OF THE DRAWING

FIG. 1 schematically illustrates an example of the apparatus for smoothing and fixing the image surface according to the present invention.

FIG. 2 schematically illustrates an example of the image-forming apparatus according to the present invention.

FIG. 3 schematically illustrates an example of the apparatus for smoothing and fixing the image surface mounted to the image-forming apparatus shown in FIG. 2.

FIG. 4 is an example of the electron microscopic picture of the porous polymer layer prepared in Example 5.

### DESCRIPTION OF THE PREFERRED EMBODIMENTS

(Electrophotographic Image-Receiving Sheet)

The electrophotographic image-receiving sheet according to the present invention comprises a support, at least two polymer layers on the support and the other layers, if necessary.

<Polymer Layer>

The polymer layers comprise at least two layers, and at least one of the polymer layers having voids. The polymer layers comprise polymer and the other additional components, if necessary.

Void

The voids are preferably included in the polymer layers except the outermost polymer layer. Specifically, (1) when a first polymer layer and a second polymer layer are disposed on the support in this order in the electrophotographic image-receiving sheet, the voids are preferably included in the first polymer layer. The voids may or may not be included in the second polymer layer. When the voids are included in the second polymer layer, the content of the voids in the second polymer layer is preferably less than that in the first polymer layer.

(2) In the case that the first polymer layer, the second polymer layer and a third polymer layer are disposed on the support in this order in the electrophotographic image-receiving sheet, the voids are preferably included in the first polymer layer and the second polymer layer. The voids may or may not be included in the third polymer layer. When the voids are included in the third polymer layer, the content of the voids in the third polymer layer is preferably less than that in the first polymer layer and the second polymer layer.

The method for forming voids in the polymer layers are not limited and may be properly selected depending on the applications. The preferable methods are as follows.
(i) adding particles having voids to the polymer layers
(ii) adding fine particles to the polymer layers
(iii) mixing foams in the coating step or adding a foaming agent in the polymer layer to form the polymer layers having porous structures.

Among them, the method (i) is preferably used from the viewpoint of easiness of forming the coating film, and method (ii) from the viewpoint of the content of the voids in the polymer layers.

The particles having voids in the method (i) are not limited as long as the voids are contained in particles and may be properly selected depending on the applications. Examples of the particles having voids include single hollow particles in which a particle has a hollow part, plural hollow particles in which a particle has several hollows, porous particles, and the like. These particles having voids may be used alone or in combination. Among them, hollow particles are preferable because of the large content of voids.

The materials of particles having voids are not limited and may be properly selected depending on the applications. For example, thermoplastic resins, and the like are preferably used. The particles having voids may be synthesized or commercially available. Examples of commercially available products include Lowpaque HP1055, and Lowpaque HP433J (by Zeon Corporation), SX866 (by JSR Co.), and the like.

The content of the voids in the polymer layers, particularly, in the polymer layers except the outermost polymer layer, is preferably 30% by volume or more, and more preferably 40% by volume or more. When the content is less than 30% by volume, the image fixing properties may not effectively improved. The content of the voids (% by volume) in the polymer layers may be measured and calculated by utilizing the microscopic observation of a section of polymer layers having voids, by measuring relative density of polymer layers having voids, or by Mercury Porosimetry in the case of porous polymer layers.

The content of voids in the particles having voids themselves is preferably 30% by volume or more, and more preferably 40% by volume to 90% by volume. When the content is less than 30% by volume, the content of voids may not sufficiently increase in the whole polymer layers. The content of voids in the particles having voids (% by volume) may be measured and calculated, for example, by utilizing the electron microscopic observation of the particles having voids, measuring the average external and internal particle diameters of the particles having voids and calculating based on the ratio of volume.

The volume average particle diameter of the particles having voids is not limited and may be properly adjusted depending on the applications. It is preferably 2 μm or less, more preferably 0.1 μm to 1.5 μm. When the volume average particle diameter is more than 2 μm, the stability of coating liquids may be impaired. The average particle diameter may be measured by the electron microscopic observation.

As for the method (ii) for adding fine particles to polymer layers, inorganic fine particles or organic fine particles may be utilized. The polymer layers having porous structures are preferably formed by coating liquids containing the fine particles during the coating process.

Examples of inorganic fine particles include fine particles of silica, colloidal silica, titanium dioxide, barium sulfate, calcium silicate, zeolite, kaolinite, hallosite, mica, talc, calcium carbonate, magnesium carbonate, calcium sulfate, pseudo boehmite, zinc oxide, zinc hydroxide, alumina, alumina silicate, calcium silicate, magnesium silicate, zirconium oxide, zirconium hydroxide, cerium oxide, lanthanum oxide, and yttrium oxide, and the like. Among them, the particles of silica, colloidal silica, pseudo boehmite, and alumina are preferable in terms of forming excellent porous structures.

The inorganic fine particles may be used in a form of primary particles or secondary particles. The average primary particle diameter of the inorganic particles is preferably 2 μm or less, and more preferably 200 nm or less. Among them, fine silica particles having an average primary particle diameter of 20 nm or less, aluminum fine particles having an average primary particle diameter of 20 nm or less, and pseudo boehmite fine particles having an average primary particle diameter of 2 nm to 15 mm are more preferable.

The fine silica particles are classified roughly into wet particles and dry particles (or gaseous) particles by the manufacturing method. In the wet method, the hydrous silica is generally obtained by the method in which active silica is formed from the acid decomposition of silicate, which is aggregated and precipitated by polymerization. On the other hand, in the dry (or gas phase) method, anhydrous silica is generally obtained by the following dry (or gaseous) methods; flame hydrolysis method in which silicon halide is hydrolyzed by high temperature gas phase reaction; and arc method in which silica sand and coke are heated to be evaporated by reduction by arc in an electric furnace, and then oxidized by air. “gas phase silica” means fine anhydrous silica particles obtained by the gas phase method. Therefore, the fine silica particles are preferably fine gas phase silica particles.

The organic fine particles (or polymer fine particles) may be used as various polymers are dispersed in hydrophilic solvents. Examples thereof include the aqueous dispersions of copolymerization of vinyl monomers, polymerization of vinyl monomers; ester polymers, urethane polymers, amide polymers, epoxy polymers, and the modification or the copolymerization thereof. Among them, the copolymerization of vinyl monomers, polymerization of vinyl monomers, and urethane polymers are preferable. The copolymerization of vinyl monomers, polymerization of vinyl monomers are particularly preferable from the viewpoint of the strength of the coating film.

Examples of the vinyl monomers include aromatic vinyl compounds such as styrene, α-methylstyrene, p-hydroxystyrene, chloromethylstyrene, and vinyltoluene; vinyl cyanide such as (meth)acrylic nitrile, and α-chloro acrylic nitrile; vinyl carboxylate such as vinyl acetate, vinyl benzoate, and vinyl formic acid; an aliphatic conjugated diene such as 1,3-butadiene and isoprene; alkyl(meth)acrylate such as methyl(meth)acrylate, ethyl(meth)acrylate, n-butyl(meth)acrylate, isobutyl(meth)acrylate, and 2-ethylhexyl(meth)acrylate; alkyl(meth)acrylate aryl such as benzyl(meth)acrylate; (meth) acrylate-substituted alkyl ethers such as glycidyl(meth)acrylate, 2-hydroxyethyl(meth)acrylate, dimethylamino ethyl(meth)acrylate, and dimethylamino propyl(meth)acrylate; alkyl(meth)acrylamide such as (meth)acrylamide, dimethyl(meth)acrylamide, n-isopropyl(meth)acrylamide, n-butyl(meth)acrylamide, tert-butyl(meth)acrylamide, and tert-octhyl (meth)acrylamide; substituted alkyl(meth)acrylamides such as dimethylamino ethyl(meth)acrylamide, and dimethylamino propyl(meth)acrylamide; polymerized oligomers such as single-end methacryloyl-based polymethyl-methacrylate-oligomers, single-end methacryloyl-based polystyrene oligomers, single-end methacryloyl-based polyethyleneglycols, and the like.

The polymer fine particles are preferably crosslinked with polyfunctional monomers. Examples of the polyfunctional monomers include aromatic divinyl compounds such as divinylbenzene, divinyl naphthalene, or derivatives thereof; ester or amide of diethylene carboxylic acids such as ethylene glycol di(meth)acrylate, trimethylolpropane tri(meth)acrylate, and dipentaerythritol hexa-(meth)acrylate; and other divinyl compounds such as divinyl sulfide compounds or divinyl sulfone compounds, and the like.

The content of the polyfunctional monomers in the polymer fine particles is preferably 2% by mol or more, and more preferably 5% by mol or more. Thus, the deformation of particles during coating and drying can be prevented and the size of the voids in the polymer layers may be larger.

The polymer fine particles are generally obtained by an emulsion polymerization method. The surfactants, polymerization initiators to be used may be ordinary in the art. The synthetic methods of the polymer fine particles are described in details in U.S. Pat. Nos. 2,852,368, 2,853,457, 3,411,911, 3,411,912, and 4,197,127, Belgian Patent Nos. 688,882, 691,360, and 712,823, Japanese Patent Application Publication UP-B) No. 45-5331, Japanese Patent Application Laid-Open (JP-A) Nos. 60-18540, 51-130217, 58-137831, 55-50240, and the like.

The average diameter of the polymer fine particles is preferably 10 nm to 100 nm and more preferably 15 nm to 80 nm. The glass transition temperatures (Tg) of the polymer fine particles are not limited and may be adjusted depending on the applications. The polymer fine particles having a high glass transition temperature and proper hardness are preferred because of preventing the deformation of particles during coating and drying, and the glass transition temperature may be adjusted in view of following conditions: the kind of the binders to be used; the ratio of the binders to the particles and the like.

The polymer fine particles are preferably the ones forming the secondary particles, so that the content of the voids in the polymer layers may be larger.

The organic particles (or polymer fine particles) crosslink and cure the coating layer (or polymer layers) which is made from coating liquid containing a water soluble resin (hereinafter referring to as “coating liquid A”). While the coating layer which is formed by coating the coating liquid A is dryed and before the falling rate drying period of the coating layer starts, a basic solution of pH8 or higher “coating liquid B” is added to the coating layer. Thereby, formed the polymer layer having porous structures.

Examples of the water soluble resins include polyvinyl alcohol resins having hydroxyl group as the hydrophilic structure unit such as polyvinyl alcohol (PVA), acetoacetyl-modified polyvinyl alcohol, the cation-modified polyvinyl alcohol, the anion-modified polyvinyl alcohol, the silanol-modified polyvinylalcohol, and polyvinyl acetal; cellulose resins such as methyl cellulose (MC), ethyl cellulose (EC), hydroxyethyl cellulose (HEC), carboxymethyl cellulose (CMC), hydroxypropyl cellulose (HPC), hydroxyethylmethyl cellulose, and hydroxypropylmethyl cellulose; chitins, chitosan, starch, and resins having ether bonds such as polyethylene oxide (PEO), polypropylene oxide (PPO), polyethylene glycol (PEG), and polyvinyl ether (PVE); resins having carbamoyl groups such as polyacrylamide (PAAM), polyvinyl pyrrolidone (PVP), and polyacrylic acid hydrazide.

Polyacrylate having a carboxyl group as dissociative group, maleic resins, alginates and gelatin may be also used.

Among them, the polyvinyl alcohol resins are particularly preferable. Examples thereof are described in JP-B Nos. 04-52786, 05-67432, 07-29479, 07-57553, Japanese Patent UP-B) Nos. 2537827, 2502998, 3053231, 2604367, 2750433, Japanese Patent Application Laid-Open (JP-A) Nos. 63-176173, 07-276787, 09-207425, 11-58941, 2000-135858, 2001-205924, 2001-287444, 62-278080, 09-39373, 2000-158801, 2001-213045, 2001-328345, 08-324105, 11-348417, and the like.

Examples of the water soluble resins except polyvinyl alcohol resins include the compounds described in [0011] to [0014] of JP-A No. 11-165461.

These water soluble resins may be used alone or in combination.

The content of the water soluble resins is preferably 4% by mass to 25% by mass, more preferably 5% by mass to 16% by mass on the basis of the total solid content in the polymer layer.

Boron compounds are preferable for crosslinking the water soluble resins, particularly such as polyvinyl alcohol. Examples of the boron compounds include borax; boric acids; borates such as orthoborate, InBO₃, ScBO₃, YBO₃, LaBO₃, Mg₃(BO₃)₂, and Co₃(BO₃)₂; and diborates such as Mg₂B₂O₅, and CO₂B₂O₅; metaborates such as LiBO₂, Ca(BO₂)₂, NaBO₂, and KBO₂; tetraborates such as Na₂B₄O₇*10H₂O; pentaborates such as KB₅O₈.0.4H₂O, Ca₂B₆O₁₁.7H₂O, and CsB₅O₅, and the like. Among them, borax, boric acids and borates are preferably used owing to the capability of conducting rapid crosslinking reactions, and more preferably boric acids.

As the crosslinkers for the water soluble resins except the boron compounds, examples thereof include aldehyde compounds such as formaldehyde, glyoxal, and glutaraldehyde; ketone compounds such as diacetyl and cyclopentanedione; active halogen compounds such as bis (2-chloroethylurea)-2-hydroxy-4,6-dichloro-1,3,5-triazine, and 2,4-dichloro-6-S-triazine sodium salt; active vinyl compounds such as divinyl sulfonic acid, 1,3-vinyl sulfonyl-2-propanol, N,N′-ethylenebis (vinylsulfonyl acetamide), and 1,3,5-triacryloyl-hexahydro-5-triazine; N-methylol compounds such as dimethylol urea, and methylol dimethylhydantoin; melamine resins such as methylol melamine, and alkylated methylol melamine; epoxy resins; isocyanate compounds such as 1,6-hexamethylene diisocyanate; aziridine compounds disclosed in U.S. Pat. Nos. 3,017,280, and 2983611; carboxyimide compounds disclosed in U.S. Pat. No. 3,100,704; epoxy compounds such as glycerol triglycidyl ether; ethylene imino compounds such as 1,6-hexamethylene-N,N′-bisethylene urea; halogenated carboxyaldehyde compounds such as mucochloric acid, and mucophenoxychloric acid; dioxane compounds such as 2,3-dihydroxydioxane; metal-containing compounds such as titanium lactate, aluminum sulfate, chromium alum, potassium alum, zirconium acetate, and chromium acetate; polyamine compounds such as tetraethylenepentamine; hydrazide compounds such as hydrazide adipate; and low molecular mass compounds or polymers having at least two oxazoline groups, and the like.

The crosslinkers may be used alone or in combination.

The crosslink setting is performed by adding the crosslinkers to at least one of the coating liquid containing polymer fine particles and the water soluble resins “coating liquid A” and the following basic solution, and also; (i) at the same time when the coating layer is formed by coating the coating liquid A, a basic solution of pH8 or higher “coating solution B” is preferably added to the coating layer; or (ii) while the coating layer which is formed by coating the coating liquid A is drying and before the falling rate drying period of the coating layer starts, a basic solution of pH8 or higher “coating solution B” is preferably added to the coating layer.

The method (iii) described above for mixing foams in the coating step or adding a foaming agent in the polymer layer to form polymer layers having porous structures is not limited and may be properly selected depending on the applications. Examples of the foaming agent may be properly selected from the conventional foaming agents depending on the applications. Examples thereof include compounds generating carbon dioxide, compounds generating nitrogen gas, compounds generating oxygen gas, microcapsule foaming agents, and the like.

Examples of the compounds generating carbon dioxide include bicarbonates such as sodium acid carbonates.

Examples of the compounds generating nitrogen gas include mixtures of NaNO₂ and NH₄Cl; azo compounds such as azobis (isobutyronitrile), and diazoaminobenzen; diazonium salts such as p-diazo dimethyl aniline chloride zinc chloride, morpholinobenzene diazonium chloride zinc chloride, morpholinobenzene diazonium chloride, fluoroborate, p-diazo ethyl aniline chloride zinc chloride, 4-(p-methyl-benzoylamino)-2,5-diethoxybenzenediazonium zinc chloride, 1,2-diazonaphthol-5-sulfonic acid sodium salts and the like.

Examples of the compounds generating oxygen gas include peroxides, and the like.

Examples of the microcapsule foaming agents include microcapsule particles containing lower boiling-point materials which vaporize at lower temperatures. The lower boiling-point materials may be either solid or liquid at room temperatures. The microcapsule foaming agents, for example, are microcapsules having a diameter of 10 μm to 20 μm of which wall materials thereof include polystyrene, polyvinyl chloride, polyvinyliden chloride, polyvinyl acetate, polyacrylic ester, polyacrylonitrile, polybutadiene, and copolymers thereof into which low-boiling volatile materials such as propane, butane, neopentane, neohexane, isopentane, isobutylene are encapsulated.

The content of the foaming agents in the polymer layer is not generally specified and varies depending on the kinds of the foaming agents, normally, preferably 1% by mass to 50% by mass.

In the present invention, a polymer layer except the outermost polymer layer preferably having voids. Among the polymer layers except the outermost polymer layer, the layer just under the outermost polymer layer preferably having the voids, which may be a toner image-receiving layer, but the undercoat layer is specifically preferable.

The outermost polymer layer comprises an aqueous polymer, and other components depending on requirements. The aqueous polymers are not limited with respect to the composition, bonding structure, molecular structure, molecular mass, molecular mass distribution, and configuration, as long as they are water soluble polymers or water dispersible polymers, may be properly selected depending on the application. Examples of substituting groups which render a resin aqueous include sulfonic acid group, hydroxy group, carboxylic acid group, amino group, amide group, and ether group, and the like.

Examples of the water-dispersible polymers include (1) polyolefin resins, (2) polystyrene resins, (3) acrylic resins, (4) polyvinyl acetate or the derivative thereof, (5) polyamide resins, (6) polyester resins, (7) polycarbonate resins, (8) polyether resins (or acetal resins) and (9) other resins. The resins and emulsions in which the thermoplastic resins of (1) to (9) are water dispersed; and copolymers thereof, mixtures thereof, and those which are cation-modified may be used in combination.

The water-dispersible polymer may be a properly synthesized product or a commercially available product. Examples of the commercially available water-dispersible polyester polymers include Vylonal Series (by Toyobo Co.), Pesresin A Series (by Takamatsu Oil & Fat Co.), Tuftone UE Series (by Kao Corporation), WR Series (by Nippon Synthetic Chemical Industry Co.), and Elitel Series (by Unitika Ltd). Examples of the commercially available water-dispersible acrylic polymers include Hiros XE, KE and PE series (by Seiko Chemical Industries Co.) and Jurymer ET series (by Nihon Junyaku Co.).

The water-dispersible emulsions are not limited and may be properly selected depending on the applications. Examples of the water-dispersible emulsion include water-dispersible polyurethane emulsions, water-dispersible polyester emulsions, chloroprene emulsions, styrene-butadiene emulsions, nitrile-butadiene emulsions, butadiene emulsions, vinyl chloride emulsions, vinylpyridine-styrene-butadiene emulsions, polybutene emulsions, polyethylene emulsions, vinyl acetate emulsions, ethylene-vinyl acetate emulsions, vinylidene chloride emulsions, and methyl methacrylate-butadiene emulsions, and the like. Among them, water-dispersible polyester emulsions are preferable.

The water-dispersible polyester emulsions are preferably self-dispersible, and among the self-dispersible polyester emulsions, self-dispersible carboxyl-containing polyester emulsions are particularly preferable. The “self-dispersible polyester emulsion” means an aqueous emulsion containing a polyester resin self-dispersible in an aqueous solvent without the use of an emulsifier and the like. The “self-dispersible carboxyl-containing polyester emulsion” means an aqueous emulsion containing a polyester resin containing a carboxyl group as hydrophilic groups and self-dispersible in an aqueous solvent.

The self-dispersing water-dispersible polyester emulsion is preferably satisfying the following (1) to (4) properties. As this is a self-dispersing type which does not use a surfactant, its hygroscopicity is low even in a high humidity environment, its softening point is not much reduced by moisture, and offset produced during fixing, or sticking of sheets in storage, can be suppressed. Moreover, since it is aqueous, it is very environment-friendly and has excellent workability. As it uses a polyester resin which easily assumes a molecular structure with high cohesion energy, it has sufficient hardness in a storage environment, assumes a melting state of low elasticity (low viscosity) in the fixing step for electrophotography, and toner is embedded in the polymer layer so that a sufficiently high quality image is attained.

(1) Number average molecular mass (Mn) is preferably 5,000 to 10,000, and more preferably 5,000 to 7,000.

(2) Molecular mass distribution (mass average molecular mass/number average molecular mass) is preferably 4 or less, and Mw/Mn≦3 is more preferably.

(3) Glass transition temperature (Tg) is preferably 40° C. to 100° C., and more preferably 50° C. to 80° C.

(4) Volume average particle diameter is preferably 20 nm to 200 nm, and more preferably 40 nm to 150 nm.

The amount of the water-dispersible emulsion in the polymer layer is preferably 10% by mass to 90% by mass, and more preferably 10% by mass to 70% by mass.

The water-soluble polymer is not limited and may be properly selected depending on the applications, and suitably synthesized or commercially available ones may be used, for example, polyvinyl alcohol, polyvinyl alcohol, carboxy-modified polyvinyl alcohol, carboxymethyl cellulose, hydroxyethyl cellulose, cellulose sulfate, polyethylene oxide, gelatin, cationized starch, casein, polyacrylic sodium, styrene-maleic anhydride copolymer sodium salt and polystyrene sulfonic acid sodium salt, and the like. Among them, polyethylene oxide is preferable.

The commercially available water-soluble polymer may be, as water-soluble polyester, various plas coat by Goo Chemical Co., Ltd., Finetex ES series by Dainippon Ink And Chemicals, Inc., as water-soluble acryl, Jurymer AT series by Nihon Junyaku Co., Ltd., Finetex 6161, K-96 by Dainippon Ink And Chemicals, Inc.; Hiross NL-1189, and BH-997L by Seiko Chemical Industry Corporation. The water-soluble polymer may be those described in Research Disclosure 17, No. 643, p. 26, Research Disclosure 18, No. 716, p. 651, Research Disclosure 307, No. 105, p. 873 to 874, and Japanese Patent Application Laid-pen UP-A) No. 64-13546.

The amount of the water-soluble polymer in the polymer layer is not limited and may be properly selected depending on the applications, and it is preferably 0.5% by mass to 10% by mass.

The electrophotographic image-receiving sheet of the invention, preferably, comprises a support, at least an undercoat layer on the support and at least a toner image-receiving layer on the undercoat layer. Preferably, the outermost polymer layer is the toner image-receiving layer, and the undercoat layer has voids, which is a polymer layer except the outermost polymer layer.

The undercoat layer and toner image-receiving layer is described in detail hereinafter.

[Undercoat Layer]

The undercoat layer has voids and polymers as mentioned above, and the other components depending on requirements. The polymers are not limited and may be properly selected depending on the applications, aqueous polymers may be preferable. Examples of the aqueous polymers include the same as those used in the polymer layers.

Unless the undercoat layer malfunctions, the undercoat layer may optionally contain other components such as releasing agents, plasticizers, fillers, crosslinkers, charge controlling agents, emulsifiers, dispersing agents, and the like.

The undercoat layer may be formed on a support by coating the support with a properly formulated coating liquid for the undercoat layer. The coating method of coating liquid is not limited and may be properly selected depending on the applications. Examples of the coating method include blade coating, air knife coating, gravure coating, roll coating, spray coating, dip coating, bar coating, extrusion coating, and spin coating, and the like.

The thickness of the undercoat layer is not limited and may be properly adjusted depending on the applications. The thickness is preferably 1 μm to 50 μm, and more preferably 3 μm to 20 μm.

[Toner Image-Receiving Layer]

The toner image-receiving layer receives a color or black toner and forms an image. The toner image-receiving layer has a function to receive toner which forms an image from a developing drum or an intermediate transfer medium by (static) electricity or pressure in a transferring step, and to fix the image by heat or pressure in a fixing step.

The toner image-receiving layer comprises at least the aqueous polymer as mentioned above. In addition, the toner image-receiving layer comprises a releasing agent, plasticizer, colorant, filler, crosslinker, charge controlling agent, emulsifier, dispersing agent, and the like, depending on requirements.

Releasing Agent

The releasing agent can be blended to the toner image-receiving layer in order to prevent offset of the toner image-receiving layer. Various types of the releasing agent may be used and may be properly selected depending on the applications as long as it is able to form a layer of the releasing agent on a surface of the toner image-receiving layer by being heated and melted at fixing temperature so as to deposit and to remain on the surface of the toner image-receiving layer, and by being cooled and solidified so as to form a layer of the releasing agent, thereafter.

The releasing agent may be at least one of silicone compounds, fluorine compounds, waxes, and matting agents.

Examples of the releasing agent include the compounds described in “Properties and Applications of Waxes, Revised Edition” (published by Saiwai Shobo) and “The Silicon Handbook” (published by THE NIKKAN KOGYO SHIMBUN). Further, preferred examples of the releasing agent include silicon compounds, fluorine compounds and waxes which are used for producing toners which are described in the following patent documents: Japanese Patent Application Publication (JP-B) Nos. 59-38581, 04-32380, Japanese Patent (JP-B) Nos. 2838498 and 2949558, JP-A Nos. 50-117433, 52-52640, 57-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-43940, 07-56387, 07-56390, 07-64335, 07-199681, 07-223362, 07-287413, 08-184992, 08-227180, 08-248671, 08-248799, 08-248801, 08-278663, 09-152739, 09-160278, 09-185181, 09-319139, 09-319143, 10-20549, 10-48889, 10-198069, 10-207116, 11-2917, 11-44969, 11-65156, 11-73049 and 11-194542. These compounds may be used in combination.

Examples of the silicone compounds include silicone oils, silicone rubbers, silicone particles, silicone-modified resins and reactive silicone compounds, and the like.

Examples of the silicone oils include unmodified silicon oil, amino-modified silicone oil, carboxy-modified silicone oil, carbinol-modified silicone oil, vinyl-modified silicone oil, epoxy-modified silicone oil, polyether-modified silicone oil, silanol-modified silicone oil, methacryl-modified silicone oil, mercapto-modified silicone oil, alcohol-modified silicone oil, alkyl-modified silicone oil and fluorine-modified silicone oil, and the like.

Examples of the silicone-modified resins include silicone-modified resins produced by silicone-modifying resins, such as an olefinic resin, a polyester resin, a vinyl resin, a polyamide resin, a cellulose resin, a phenoxy resin, a vinyl chloride-vinyl acetate resin, an urethane resin, an acrylic resin, a styrene-acrylic resin or a silicone-modified resin produced by a copolymer resin thereof, and the like.

The fluorine compounds are not limited and may be properly selected depending on the applications. Examples of the fluorine compounds include fluorocarbon oil, fluorocarbon rubber, fluorine-modified resin, fluorosulfonic acid compound, fluorosulfonic acid, fluoric acid compound and salts thereof and inorganic fluoride, and the like.

The wax is generally classified into a natural wax and a synthesized wax. Preferred examples of the natural wax include vegetable wax, animal wax, mineral wax and petroleum wax, and the like. Among them, the vegetable wax is specifically preferred. As the natural wax is preferably a water-dispersible wax particularly from the viewpoint of the compatibility when a aqueous resin is used as the polymer in the toner image-receiving layer.

The vegetable wax is not limited and may be properly selected from conventional vegetable waxes which may be properly synthesized or commercially available. Examples of the vegetable wax include carnauba wax, castor oil, rape oil, soy bean oil, Japan tallow, cotton wax, rice wax, sugarcane wax, candelilla wax, Japan wax and jojoba oil, and the like.

Examples of the carnauba wax which is commercially available include EMUSTAR-0413 (by Nippon Seiro Co., Ltd.) and SELOSOL 524 (by Chukyo Yushi Co., Ltd.). Examples of the castor oil which is commercially available include purified castor oil (by Itoh Oil Chemicals Co., Ltd).

Among them, the carnauba wax having a melting point of from 70° C. to 95° C. is most preferable from the viewpoint of providing an electrophotographic image-receiving sheet which is excellent particularly in anti-offset properties, adhesion resistance, conveyability and glossiness, and in which the cracking is hardly caused and an image having a high quality can be formed.

The animal wax is not limited and may be properly selected from conventional animal waxes which may be commercially available or properly synthesized. Examples of the animal wax include bees wax, lanolin, spermaceti wax, whale oil and wool wax, and the like.

The mineral wax is not limited and may be properly selected form conventional mineral waxes which may be commercially available or properly synthesized. Examples of the mineral wax include montan wax, montan ester wax, ozokerite and ceresin.

Among them, particularly from the viewpoint of providing an electrophotographic image-receiving sheet which is excellent particularly in anti-offset properties, adhesion resistance, conveyability and glossiness, and in which the cracking is hardly caused and an image having a high quality can be formed, the montan wax having a melting point of from 70° C. to 95° C. is most preferred.

The petroleum wax is not limited and may be properly selected conventional petroleum waxes which may be commercially available or properly synthesized. Examples of the petroleum wax include paraffin wax, microcrystalline wax and petrolatum, and the like.

The amount of the natural wax in the toner image-receiving layer is preferably from 0.1 g/m² to 4 g/m², more preferably from 0.2 g/m² to 2 g/m².

When the amount is less than 0.1 g/m², the anti-offset properties and the adhesion resistance of the electrophotographic image-receiving sheet may be particularly impaired. On the other hand, when the amount is more than 4 g/m², the quality of the image formed on the electrophotographic image-receiving sheet may be impaired due to excessive wax.

The melting point of the natural wax is, particularly from the viewpoint of the anti-offset properties and the conveyability, preferably from 70° C. to 95° C., more preferably from 75° C. to 90° C.

The synthetic wax is classified into a synthetic hydrocarbon, a modified wax, a hydrogenated wax and other synthetic waxes produced from fats and oils. As the wax, from the viewpoint of the compatibility of the wax with a hydrophilic thermoplastic resin used as a thermoplastic resin for producing the toner image-receiving layer, a water-dispersible wax is preferred.

Examples of the synthetic hydrocarbon include a Fischer-Tropsch wax and a polyethylene wax.

Examples of the synthetic wax produced from fats and oils include an acid amide compound such as stearamide and an acid imide compound such as anhydrous phthalimide, and the like.

The modified wax is not limited and may be properly selected depending on the applications. Examples of the modified wax include an amine-modified wax, an acrylic acid-modified wax, a fluorine-modified wax, an olefin-modified wax, a urethane wax and an alcohol wax, and the like.

The hydrogenated wax is not limited and may be properly selected depending on the applications. Examples of the hydrogenated wax include hard castor oil, castor oil derivative, stearic acid, lauric acid, myristic acid, palmitic acid, behenic acid, sebacic acid, undecylenic acid, heptyl acid, maleic acid and a highly maleinated oil, and the like.

The matting agent may be properly selected from any conventional matting agent. Solid particles used as the matting agent can be classified into inorganic particles and organic particles. Specifically, the inorganic matting agents may be oxides such as silicon dioxide, titanium oxide, magnesium oxide, aluminum oxide, alkaline earth metal salts such as barium sulfate, calcium carbonate, and magnesium sulfate, silver halides such as silver chloride, and silver bromide, glass, and the like.

Examples of the inorganic matting agents may be found, for example, in West German Patent No. 2,529,321; G.B. Patent Nos. 760,775 and U.S. Pat. No. 1,260,772; and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Materials of the organic matting agent include starch, cellulose ester such as cellulose-acetate propionate, cellulose ether such as ethyl cellulose, and a synthetic resin. It is preferred that the synthetic resin is insoluble or difficult to become solved. Examples of synthetic resins that are insoluble or of low solubility in water include poly(meth)acrylates such as polyalkyl(meth)acrylate, polyalkoxyalkyl(meth)acrylate, polyglycidyl(meth)acrylate, poly(meth)acrylamide, polyvinyl ester such as polyvinyl acetate, polyacrylonitrile, polyolefins such as example, polyethylene, polystyrene, benzoguanamine resin, formaldehyde condensation polymer, epoxy resin, polyamide, polycarbonate, phenolic resin, polyvinyl carbazole, polyvinylidene chloride, and the like.

Copolymers which combine the monomers used in the above polymers, may also be used.

In the case of the copolymers, a small amount of hydrophilic repeating units may be included. Examples of monomers which constitute these hydrophilic repeating units include acrylic acid, methacrylic acid, α, β-unsaturated dicarboxylic acid, hydroxyalkyl(meth)acrylate, sulfoalkyl (meth)acrylate, styrene sulfonic acid, and the like.

Examples of the organic matting agents can be found, for example, in G.B. Patent No. 1,055,713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821 and 57-14835.

Also, two or more types of solid particles may be used in combination. The average particle diameter of the solid particles may suitably be, for example, 1 μm to 100 μm, and is more preferably 4 μm to 30 μm. The usage amount of the solid particles may suitably be 0.01 g/m² to 0.5 g/m², and is more preferably 0.02 g/m² to 0.3 g/m².

The melting point (° C.) of the releasing agent is preferably 70° C. to 95° C., and more preferably 75° C. to 90° C., from the viewpoints of anti-offset properties and paper transport properties.

As the releasing agent incorporated in the composition of the toner image-receiving layer of the present invention, a derivative, an oxide, a refined product and a mixture of the above-exemplified releasing agents may be also used. These releasing agents may have a reactive substituent.

The content of the releasing agent in the toner image-receiving layer is preferably 0.1% by mass to 10% by mass, more preferably 0.3% by mass to 8.0% by mass, and still more preferably 0.5% by mass to 5.0% by mass. When the amount is less than 0.1% by mass, offset resistance and adhesion resistance of the electrophotographic image-receiving sheet may be poor sometimes. When the amount is more than 10% by mass, the quality of the image to be formed may be unsatisfactory due to excessive releasing agent sometimes.

Plasticizer

The plasticizer is not limited and may be properly selected from conventional plasticizers used for resins depending on the applications. The plasticizer has a function of controlling the fluidizing and softening of the toner image-receiving layer by the heat and pressure applied on the toner image-receiving layer during fixing the toner.

Examples of a reference for selecting the plasticizer include literatures, such as “Chemical Handbook” (Kagaku Binran) edited by The Chemical Society of Japan and published by Maruzen Co., Ltd., “Plasticizer, Theory and Application” edited by Koichi Murai and published by Saiwai Shobo, “Volumes 1 and 2 of Studies on Plasticizer” edited by Polymer Chemistry Association, and “Handbook on Compounding Ingredients for Rubbers and Plastics” edited by Rubber Digest Co.

Some plasticizers are described as an organic solvent having a high boiling point or a heat solvent in some literatures. Examples of the plasticizer include compound such as esters such as phthalate esters, phosphorate esters, fatty esters, abietate esters, adipate esters, sebacate esters, azelate esters, benzoate esters, butyrate esters, epoxidized fatty esters, glycolate esters, propionate esters, trimellitate esters, citrate esters, sulfonate esters, carboxylate esters, succinate esters, malate esters, fumarate esters, phthalate esters and stearate esters; amides such as fatty amides and sulfonate amides; ethers; alcohols; lactones and polyethylene oxides, which are described in patent documents, such as JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and 2-235694.

These plasticizers may be incorporated in the composition of the resin.

Further, a plasticizer having a relatively low molecular mass can be also used. The plasticizer has a molecular mass which is preferably lower than that of a binder resin which is plasticized by the plasticizer and preferably 15,000 or less, more preferably 5,000 or less. In addition, when a plasticizer is a polymer, the plasticizer is preferably the same polymer as that of the binder resin which is plasticized by the plasticizer. For example, for plasticizing a polyester resin, the plasticizer is preferably a polyester having a low molecular mass. Further, an oligomer can be also used as a plasticizer.

Besides the above-noted compounds, examples of the plasticizer which is commercially available include Adekacizer PN-170 and PN-1430 (by Asahi Denka Kogyo Co., Ltd.); PARAPLEX G-25, G-30 and G-40 (by C. P. Hall Co., Ltd.); and Ester Gum 8L-JA, Ester R-95, Pentalin 4851, FK 115, 4820, 830, Luisol 28-JA, Picolastic A75, Picotex LC and Crystalex 3085 (by Rika Hercules Co., Ltd.), and the like.

The plasticizer may be optionally used for relaxing the stress and strain (i.e., a physical strain, such as a strain in elastic force and viscosity and a strain due to a material balance in the molecule and the backbone chain and pendant moiety of the binder) which are caused when the toner particles are embedded in the toner image-receiving layer.

In the toner image-receiving layer, the plasticizer may be finely (microscopically) dispersed, may be in the state of a fine phase-separation in a sea-island structure and may be compatibilized with other components, such as a binder resin.

The amount of the plasticizer in the toner image-receiving layer is preferably 0.001% by mass to 90% by mass, more preferably 0.1% by mass to 60% by mass, still more preferably 1% by mass to 40% by mass, based on the mass of the toner image-receiving layer.

The plasticizer may be used for controlling slip properties (for improving the conveyability by reducing the friction), improving the offset of the toner at the fixing part of the fixing apparatus (peeling of the toner or the toner image-receiving layer to the fixing part) and controlling the curling balance and electrostatic charge (formation of a toner electrostatic image).

Colorant

The colorant is not limited and may be properly selected depending on the applications. Examples of the colorant include a fluorescent whitening agent, a white pigment, a colored pigment and a dye.

The fluorescent whitening agent is not limited so long as the agent is a conventional compound having an absorption in the near-ultraviolet region and emitting a fluorescence having a wavelength of 400 nm to 500 nm and may be properly selected from conventional fluorescent whitening agents. Preferred examples of the fluorescent whitening agent include the compounds described in “The Chemistry of Synthetic Dyes, Volume V” Chapter 8 edited by K. Veen Rataraman. The fluorescent whitening agent may be a commercially available product or a properly synthesized product. Examples of the fluorescent whitening agent include stilbene compounds, coumarin compounds, biphenyl compounds, benzo-oxazoline compounds, naphthalimide compounds, pyrazoline compounds and carbostyril compounds. Examples of the commercially available fluorescent whitening agent include white furfar-PSN, PHR, HCS, PCS and B (by Sumitomo Chemicals Co., Ltd.) and UVITEX-OB (by Ciba-Geigy Corp.), and the like.

The white pigment is not limited and may be properly selected from conventional white pigments depending on the applications. Examples of the white pigment include an inorganic pigment, such as titanium oxide and calcium carbonate, and the like.

The colored pigment is not limited and may be properly selected from conventional colored pigments. Examples of the colored pigment include various pigments described in JP-A No. 6344653, such as an azo pigment, a polycyclic pigment, a condensed polycyclic pigment, a lake pigment and a carbon black, and the like.

Examples of the azo pigment include an azo lake pigment (such as carmine 6B and red 2B), an insoluble azo pigment (such as monoazo yellow, disazo yellow, pyrazolone orange and Vulcan orange) and a condensed azo pigment (such as chromophthal yellow and chromophthal red), and the like.

Examples of the polycyclic pigment include a phthalocyanine pigment, such as copper phthalocyanine blue and copper phthalocyanine green, and the like.

Examples of the condensed polycyclic pigment include a dioxazine pigment such as dioxazine violet, an isoindolinone pigment such as isoindolinone yellow, a threne pigment, a perylene pigment, a perinone pigment and a thioindigo pigment, and the like.

Examples of the lake pigment include malachite green, rhodamine B, rhodamine G and Victoria blue B, and the like.

Examples of the inorganic pigment include an oxide such as titanium dioxide and iron oxide red, a sulfate salt such as precipitated barium sulfate, a carbonate salt such as precipitated calcium carbonate, a silicate salt such as a hydrous silicate salt and an anhydrous silicate salt, and a metal powder such as aluminum powder, bronze powder, zinc powder, chrome yellow and iron blue, and the like.

These pigments may be used alone or in combination.

The dye is not limited and may be properly selected from conventional dyes depending on the applications. Examples of the dye include anthraquinone compounds and azo compounds, and the like. These dyes may be used alone or in combination.

Examples of the water-insoluble dye include a vat dye, a disperse dye and an oil-soluble dye, and the like. Specific examples of the vat dye include C. I. Vat violet 1, C. I. Vat violet 2, C. I. Vat violet 9, C. I. Vat violet 13, C. I. Vat violet 21, C. I. Vat blue 1, C. I. Vat blue 3, C. I. Vat blue 4, C. I. Vat blue 6, C. I. Vat blue 14, C. I. Vat blue 20 and C. I. Vat blue 35, and the like. Specific examples of the disperse dye include C. I. disperse violet 1, C. I. disperse violet 4, C. I. disperse violet 10, C. I. disperse blue 3, C. I. disperse blue 7 and C. I. disperse blue 58, and the like. Specific examples of the oil-soluble dye include C. I. solvent violet 13, C. I. solvent violet 14, C. I. solvent violet 21, C. I. solvent violet 27, C. I. solvent blue 11, C. I. solvent blue 12, C. I. solvent blue 25 and C. I. solvent blue 55, and the like.

Colored couplers used in the silver salt photography may also be used preferably as the dye.

The amount of the colorant in the toner image-receiving layer is preferably 0.1 g/m² to 8 g/m², more preferably 0.5 g/m² to 5 g/m².

When the amount of the colorant is less than 0.1 g/m², the light transmittance of the toner image-receiving layer may be high. On the other hand, when the amount is more than 8 g/m², handling properties, such as crack and adhesion resistance may be impaired.

Examples of the fillers include an organic filler and an inorganic filler which is a reinforcing agent for the binder resin or a conventional filler as a reinforcer or a bulking agent. The filler may be properly selected by referring to “Handbook of Rubber and Plastics Additives” edited by Rubber Digest Co., “Plastics Blending Agents—Basics and Applications” (New Edition) published by Taisei Co. and “The Filler Handbook” published by Taisei Co.

Examples of the filler include an inorganic filler and an inorganic pigment. Specific examples of the inorganic filler or the inorganic pigment include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite, and the like. Among them, silica and alumina are most preferred. These fillers may be used alone or in combination. It is preferred that the filler has a small particle diameter. When the filler has a large particle diameter, the surface of the toner image-receiving layer is easily roughened.

Examples of the silica include a spherical silica and an amorphous silica. The silica can be synthesized by a dry method, a wet method or an aerogel method. The silica may be also produced by treating the surface of the hydrophobic silica particles with a trimethylsilyl group or silicone. Preferred examples of the silica include a colloidal silica. The silica is preferably porous.

Examples of the alumina include an anhydrous alumina and a hydrated alumina. Examples of the crystallized anhydrous alumina include α-type, β-type, γ-type, δ-type, ξ-type, η-type, θ-type, κ-type, ρ-type and χ-type anhydrous alumina. The hydrated alumina is more preferred than the anhydrous alumina. Examples of the hydrated alumina include a monohydrated alumina and a trihydrate alumina. Examples of the monohydrated alumina include pseudo-boehmite, boehmite and diaspore. Examples of the trihydrated alumina include gibbsite and bayerite. The alumina is preferably porous.

The hydrated alumina can be synthesized by the sol-gel method in which ammonia is added to a solution of an aluminum salt to precipitate alumina or by a method of hydrolyzing an alkali aluminate. The anhydrous alumina can be obtained by heating to dehydrate a hydrated alumina.

The amount of the filler is preferably 5 parts by mass to 2,000 parts by mass, relative to 100 parts by mass (in terms of dry mass) of the binder resin in the toner image-receiving layer.

The crosslinking agent may be incorporated in the resin composition of the toner image-receiving layer for controlling the shelf stability and thermoplasticity of the toner image-receiving layer. Examples of the crosslinking agent include a compound containing in the molecule two or more reactive groups selected from the group consisting of an epoxy group, an isocyanate group, an aldehyde group, an active halogen group, an active methylene group, an acetylene group and other conventional reactive groups.

Examples of the crosslinking agent include also a compound containing in the molecule two or more groups which can form a bond through a hydrogen bond, an ionic bond or a coordination bond.

Specific examples of the crosslinking agent include a compound which is conventional as a coupling agent, a curing agent, a polymerizing agent, a polymerization promoter, a coagulant, a film-forming agent or a film-forming assistant which are used for the resin. Examples of the coupling agent include chlorosilanes, vinylsilanes, epoxisilanes, aminosilanes, alkoxy aluminum chelates, titanate coupling agents and other conventional crosslinking agents described in “Handbook of Rubber and Plastics Additives” (edited by Rubber Digest Co.).

The toner image-receiving layer preferably comprises a charge controlling agent for controlling the transfer and adhesion of the toner and for preventing the adhesion of the toner image-receiving layer due to the charge.

The charge controlling agent is not limited and may be properly selected from conventional various charge controlling agents depending on the applications. Examples of the charge controlling agent include a surfactant, such as a cationic surfactant, an anionic surfactant, an amphoteric surfactant and a non-ionic surfactant; a polymer electrolyte and a conductive metal oxide. Specific examples of the charge controlling agent include a cationic antistatic agent, such as a quaternary ammonium salt, a polyamine derivative, a cation-modified polymethyl methacrylate, a cation-modified polystyrene; an alkyl phosphate, an anionic antistatic agent, such as an alkyl phosphate and an anionic polymer; and a non-ionic antistatic agent, such as a fatty ester and a polyethylene oxide, and the like.

When the toner is negatively charged, the charge controlling agent in the toner image-receiving layer is preferably a cationic or nonionic charge controlling agent.

Examples of the conductive metal oxide include ZnO, TiO₂, SnO₂, Al₂O₃, In₂O₃, SiO₂, MgO, BaO and MoO₃. These conductive metal oxides may be used alone or in combination. The conductive metal oxide may contain (dope) another different element, for example, ZnO may contain (dope) Al and In; TiO₂ may contain (dope) Nb and Ta; and SnO₂ may contain (dope) Sb, Nb and a halogen element, and the like.

Other Additives

The toner image-receiving layer of the present invention may comprise also various additives for improving the stability of the output image or the stability of the toner image-receiving layer itself. Examples of the additive include various conventional antioxidants, anti-aging agents, deterioration inhibitors, ozone-deterioration inhibitors, ultraviolet light absorbers, metal complexes, light stabilizers, antiseptic agents and anti-fungus agents, and the like.

The antioxidant is not limited and may be properly selected depending on the applications. Examples of the antioxidant include a chroman compound, a coumarin compound, a phenol compound (e.g., a hindered phenol), a hydroquinone derivative, a hindered amine derivative and a spiroindan compound, and the like. With respect to the antioxidant, there is a description in JP-A No. 61-159644.

The anti-aging agent is not limited and may be properly selected depending on the applications. Examples of the anti-aging agent include anti-aging agents described in “Handbook of Rubber and Plastics Additives—Revised Second Edition” (published by Rubber Digest Co., 1993, pp. 76-121).

The ultraviolet light absorber is not limited and may be properly selected depending on the applications. Examples of the ultraviolet light absorber include a benzotriazol compound (see U.S. Pat. No. 3,533,794), a 4-thiazolidone compound (see U.S. Pat. No. 3,352,681), a benzophenone compound (see JP-A No. 46-2784) and an ultraviolet light absorbing polymer (see JP-A No. 62-260152).

The metal complex is not limited and may be properly selected depending on the applications. Proper examples of the metal complex include metal complexes described in U.S. Pat. Nos. 4,241,155, 4,245,018, and 4,254,195; and JP-A Nos. 61-88256, 62-174741, 63-199248, 01-75568 and 01-74272.

Also, preferred examples of the ultraviolet light absorber or the light stabilizer include ultraviolet light absorbers or light stabilizers described in “Handbook of Rubbers and Plastics Additives—Revised Second Edition” published by Rubber Digest Co., 1993, pp. 122-137.

The toner image-receiving layer may optionally comprise the above-noted conventional additives for the photography. Examples of the additive for the photography include additives described in “Journal of Research Disclosure (hereinafter referred to as RD) No. 17643 (December, 1978), No. 18716 (November, 1979) and No. 307105 (November, 1989)”. These additives are specifically noted with respect to the pages of the Journal RD which are to be referred to a table as shown in the following Table 1.

TABLE 1

| | | Journal No. | | |
|---|---|---|---|---|
| Type of additives | | RD17643 | RD18716 | RD307105 |
| 1. | Whitening agent | p. 24 | p. 648 right column | p. 868 |
| 2. | Stabilizer | pp. 24-25 | p. 649 right column | pp. 868-870 |
| 3. | Light absorber | pp. 25-26 | p. 649 right column | p. 873 |
| | (Ultraviolet light | | | |
| | absorber) | | | |
| 4. | Dye image stabilizer | p. 25 | p. 650 right column | p. 872 |
| 5. | Film hardener | p. 26 | p. 651 left column | pp. 874-875 |
| 6. | Binder | p. 26 | p. 651 left column | pp. 873-874 |
| 7. | Plasticizer, lubricant | p. 27 | p. 650 right column | p. 876 |
| 8. | Auxiliary coating | pp. 26-27 | p. 650 right column | pp. 875-876 |
| | agent (Surfactant) | | | |
| 9. | Antistatic agent | p. 27 | p. 650 right column | pp. 876-877 |
| 10. | Matting agent | — | — | pp. 878-879 |

The toner image-receiving layer is disposed on the support by coating the support with the coating liquid containing a thermoplastic resin used for the toner image-receiving layer with a wire coater and the like and drying the coating solution. The Minimum Film Forming Temperature (MFT) of the thermoplastic resin used in the present invention is preferably room temperature or higher during the storage of the electrophotographic image-receiving sheet before the printing and preferably 100° C. or less during the fixing of the toner particles. The amount of the dried coating on the toner image-receiving layer is preferably 1 g/m² to 20 g/m², more preferably 4 g/m² to 15 g/m².

The total thickness of the toner image-receiving layer is not limited and may be properly selected depending on the applications. Examples of the thickness is preferably ½ or more of the diameter of the toner particles, more preferably from 1 time to 3 times of the diameter of the toner particles. Specifically, the thickness is preferably from 1 μm to 50 μm, more preferably from 1 μm to 30 μm, still more preferably from 2 μm to 20 μm, most preferably from 5 μm to 15 μm.

[Physical Properties of Toner Image-Receiving Layer]

The 180-degree separation strength of the toner image-receiving layer at the temperature for the image-fixing at which the image is fixed on the fixing member is preferably 0.1N/25 mm or less, more preferably 0.041N/25 mm or less. The 180-degree separation strength can be measured according to the method described in JIS K6887 using a surface material of the fixing member.

It is preferred that the toner image-receiving layer has a high degree of whiteness. The whiteness is measured by the method described in JIS P 8123 and is preferably 85% or more. It is preferred that the spectral reflectance of the toner image-receiving layer is 85% or more in the wavelength range of from 440 nm to 640 nm and the difference between the maximum spectral reflectance of the toner image-receiving layer and the minimum spectral reflectance of the toner image-receiving layer in the wavelength range is within 5%. Further, it is more preferred that the spectral reflectance of the toner image-receiving layer is 85% or more in the wavelength range of 400 nm to 700 nm and the difference between the maximum spectral reflectance of the toner image-receiving layer and the minimum spectral reflectance of the toner image-receiving layer in the wavelength range is within 5%.

With respect to the whiteness of the toner image-receiving layer, specifically, an L* value is preferably 80 or higher, more preferably 85 or higher, still more preferably 90 or higher in the CIE 1976 (L*a*b*) color space. The color tint of the white color is preferably as neutral as possible and more specifically, with respect to the color tint of the whiteness, the value of (a*)²+(b*)² is preferably 50 or less, more preferably 18 or less, still more preferably 5 or less in the (L*a*b*) space.

It is preferred that the toner image-receiving layer has high gloss after the image-forming. With respect to the surface gloss of the toner image-receiving layer, the 45-degree surface gloss is preferably 60 or higher, more preferably 75 or higher, still more preferably 90 or higher over the whole range from white where there is no toner, to black where toner is densed at maximum. However, the surface gloss of the toner image-receiving layer is preferably 110 or less. When the surface gloss is more than 110, the image has a metallic gloss and such a quality of the image is undesirable.

The surface gloss can be measured according to JIS Z8741.

The toner image-receiving layer has a preferably excellent smoothness after the fixing. With respect to the smoothness of the toner image-receiving layer, the arithmetic average roughness (Ra) of the toner image-receiving layer is preferably 3 μm or less, more preferably 1 μm or less, still more preferably 0.5 μm or less over the whole range from white where there is no toner, to black where toner is densed at maximum.

The arithmetic average roughness may be measured, for example, according to the methods described in JIS B 0601, B 0651 and B 0652.

The toner image-receiving layer has preferably one of the physical properties described in the following items (1) to (6), more preferably several of them, most preferably all of them.

(1) The melting temperature (Tₘ) of the toner image-receiving layer is preferably 30° C. or higher, more preferably a temperature which is higher than Tₘ of the toner by 20° C., or lower.

(2) The temperature at which the viscosity of the toner image-receiving layer is 1×10⁵ cp is preferably 40° C. or higher, more preferably a temperature which is lower than the temperature at which the viscosity of the toner is 1×10⁵ cp.

(3) The storage elasticity modulus (G′) of the toner image-receiving layer at the temperature for the image-fixing is preferably from 1×10² Pa to 1×10⁵ Pa and the loss elasticity modulus (G″) of the toner image-receiving layer at the temperature for the image-fixing is preferably from 1×10² Pa to 1×10⁵ Pa.

(4) The loss tangent (G″/G′) of the toner image-receiving layer at the temperature for the image-fixing is preferably from 0.01 to 10, wherein the loss tangent is the ratio of the loss elasticity modulus (G″) to the storage elasticity modulus (G′).

(5) The storage elasticity modulus (G′) of the toner image-receiving layer at the fixing temperature differs from the storage elasticity modulus (G′) of the toner at the fixing temperature, preferably by −50 to +2,500.

(6) The inclination angle of the molten toner on the toner image-receiving layer is preferably 50° or less, more preferably 40° or less.

The toner image-receiving layer preferably satisfies the physical properties described in Japanese Patent No. 2788358 and JP-A Nos. 07-248637, 08-305067 and 10-239889.

The surface electrical resistance of the toner image-receiving layer is preferably in the range of from 1×10⁶ Ω/cm² to 1×10¹⁵ Ω/cm² (under conditions of 25° C. and 65% Relative Humidity).

When the surface electrical resistance is less than 1×10⁶ Ω/cm², the amount of the toner transferred to the toner image-receiving layer is insufficient, and the density of the obtained toner image may be too low easily. On the other hand, when the surface electrical resistance is more than 1×10¹⁵ Ω/cm², more charge than the necessary is generated during the transferring. Therefore, toner is transferred insufficiently, image density is low and static electricity develops causing dust to adhere during handling of the electrophotographic image-receiving sheet, or misfeed, overfeed, discharge marks or toner transfer dropout may occur during copying.

The surface electrical resistance are measured based on JIS K6911. The sample is left under the condition where the temperature is 20° C. and the humidity is 65% for 8 hours or more and after applying a voltage of 100V to the sample for 1 minute under the same condition as the above-noted condition, the surface electrical resistance of the toner image-receiving layer is measured using a micro-ammeter R8340 (by Advantest Ltd.).

<Support>

The support is not limited and may be properly selected from the conventional supports for electrophotographic image-receiving sheet depending on the applications, for example, a raw paper, a synthetic paper, a synthetic resin sheet, a coated paper, and a laminated paper, and the like. Among them, coated paper comprising polyolefin resin layer on both surfaces of a raw paper is preferable. The support may be a single layer composition, or a laminated structure of two or more layers.

Raw Paper

The raw paper is not limited, and may be properly selected depending on the applications, specifically, a fine paper, for example, the paper reported in pp. 223 to 224 of “The Basic of Photographic Engineering-Silver Salt Photograph Volume” edited by The Society of Photographic Science and Technology of Japan, Corona Corporation (issued 1979) is suitable.

The raw paper is not limited and may be properly selected from the conventional raw papers used for support depending on the applications. Examples include natural pulp of conifer and broadleaf tree, and a mixture of the natural pulp and synthetic pulp, and the like.

The pulp that can be used as the material of the raw paper is desirable to be bleached broadleaf tree kraft pulp (LBKP), but bleached conifer kraft pulp (NBKP) and broadleaf tree sulfite pulp (LBSP) may also be used because they enhance the surface smoothness, stiffness and dimension stability (curl property) of the raw paper at the same time with good balance and to sufficient level.

As the beating of the pulp, a beater and a refiner can be used.

The Canada Standard Filtered Water Degree of the pulp is preferably 200 ml to 440 ml C.S.F., and more preferably 250 ml to 380 ml C.S.F. because in the paper making step, the shrinkage of the paper can be controlled.

Various additives, for example, fillers, dry paper reinforcers, sizing agents, wet paper reinforcers, fixing agents, pH regulators or other agents, and the like may be added, if necessary, to the pulp slurry (hereafter, may be referred to as pulp paper material) which is obtained after beating the pulp.

Examples of the fillers include calcium carbonate, clay, kaolin, China clay, talc, titanium oxide, diatomite, barium sulfate, aluminum hydroxide, and magnesium hydroxide, and the like. Examples of the dry paper reinforcers cationized starch, cationized polyacrylamide, anionized polyacrylamide, ampholytic polyacrylamide, and carboxy-modified polyvinyl alcohol, and the like.

Examples of the sizing agents include compound comprises higher fatty acid such as higher fatty acid salt; rosin derivatives such as rosin and rosin maleate rosin; paraffin wax, alkylketene dimer, alkenyl succinic anhydride (ASA); and epoxidized fatty amide, and the like.

Examples of the wet paper reinforcers include polyamine polyamide epichlorohydrin, melamine resin, urea resin, and epoxidized polyamide resin, and the like. Examples of the fixing agents include polyvalent metal salt such as aluminum sulfate and aluminum chloride; cationic polymer such as cationized starch, and the like.

Examples of the pH regulators include caustic soda and sodium carbonate, and the like.

Examples of other agents include defoaming agents, dyes, slime control agents, fluorescent whitening agents, and the like.

Further, flexibilizer may be added if necessary. The flexibilizer, for example, may be the one described in “New Paper Processing Handbook”, pp. 554 to 555, edited by Kamiyaku Time Corporation (issued 1980).

These various additives may be used alone or in combination. Also, the amount of these various additives to be added to the pulp paper material is not limited and may be properly selected depending on the applications, generally, preferably 0.1% by mass to 1.0% by mass.

For the pulp slurry, further, according to necessity, pulp paper material comprising the above-mentioned various additives is paper-made using paper machine such as a hand paper machine, a wire paper machine, a cylinder paper machine, a twin wire machine and a combination machine, and after that dried, and a raw paper is made. Also, according to desire, the surface size treatment can be carried out any one of before and after the drying.

The treatment solution used for sizing a surface is not limited and may be suitably selected depending on the applications, for example, may comprise a water-soluble polymer compound, a water-resistant substance, a pigment, a dye and a fluorescent whitening agent, and the like.

The water-soluble polymer compound, for example, may be cationized starch, polyvinyl alcohol, carboxy-modified polyvinyl alcohol, carboxymethyl cellulose, hydroxyethyl cellulose, cellulose sulfate, gelatin, casein, polyacrylic sodium, styrene-maleic anhydride copolymer sodium salt and polystyrene sulfonic acid sodium salt, and the like.

The water-resistant substance, for example, may be latex emulsion such as styrene-butadiene copolymer, ethylene-vinyl acetate copolymer, polyethylene and vinylidene chloride copolymer, and polyamide-polyamine-epichlorohydrin, and the like.

The pigment, for example, may be calcium carbonate, clay, kaolin, talc, barium sulfate and titanium oxide, and the like.

For the raw paper, in an attempt to improve the rigidity and dimensional stability (curl properties), the ratio (Ea/Eb) of vertical direction Young's modulus (Ea) to horizontal direction Young's modulus Eb is preferably in the range of 1.5 to 2.0. In the range of the value of Ea/Eb is less than 1.5, or more than 2.0, it is not preferable because the rigidity and the curl properties of the recording material is likely to be inferior, and may interfere with paper during the conveying operation.

Generally, it is understood that the “stiffness” of the paper differs depending on the various manners in which the paper is beaten, and after beating, the elastic force (rate) of the paper produced by paper making can be used as an important factor to show the degree of “stiffness” of the paper. By making use of the relation of the dynamic elastic modulus and density showing the properties of viscoelastic material of the paper, and using the ultrasonic vibrating element to this, and measuring the sound velocity transmitting all over the paper, the elastic modulus of the paper can be seek according to the following equation in particular.
E=ρc²(1−n²)
where “E” implies dynamic elastic modulus. “ρ” represents density. “c” represents sound velocity all over the paper. “n” represents Poisson's ratio.

Also, in the case of ordinary paper, as n=0.2 approximately, there is no great difference even by calculating with the following equation, and can be calculated.
E=ρc²

Namely, if the density and sound velocity of the paper can be measured, elastic modulus can be easily found. In the above equation, when measuring sound velocity, various conventional apparatuses such as Sonic Tester-SST-110 by Nomura Shoji Co., Ltd. may be used.

For the raw paper, in order to give desired center line average roughness on the surface, for example, as reported in Japanese Patent Application Laid-Open (JP-A) No. 58-68037, it is preferable to use pulp fiber of fiber length distribution (for example the total of 24 mesh screen residue and 42 mesh screen residue, for example, is 20% by mass to 45% by mass, and 24 mesh screen residue is 5% by mass or less. Also, the center line average roughness can be adjusted by adding heating and pressuring to a surface of the raw paper, with a machine calender and super calender, and the like.

The thickness of the raw paper is not limited and may be properly selected depending on the applications, generally, preferably 30 μm to 500 μm, more preferably 50 μm to 300 μm, and still more preferably 100 μm to 250 μm. The basis weight of the raw paper is not limited and may be properly selected depending on the applications, for example, preferably 50 g/m² to 250 g/m², and more preferably 10 g/m² to 200 g/m².

Synthetic Paper

The synthetic paper is a paper with polymer fiber except cellulose as a main component, and the polymer fiber, for example, may be polyolefin fiber such as polyethylene and polypropylene, and the like.

Synthetic Resin Sheet (Film)

The synthetic resin sheet (film) may be a film formed in a sheet shape from synthetic resin, for example, polypropylene film, stretched polyethylene film, stretched polypropylene film, polyester film, stretched polyester film, and nylon film, and the like. In addition, white-colored film by stretching, white color film comprising white color pigment may also be used.

Coated Paper

The coated paper is a paper where various resins are coated on one surface or both surfaces on a substrate of a raw paper, and the coating amount differs according to the application. Examples of the coated paper include an art paper, a cast coat paper, and a Yankee paper, and the like.

The resin with which the surface of the raw paper is coated is not limited may be properly selected depending on the applications. Preferable examples are thermoplastic resins. Examples of the thermoplastic resin include (1) polyolefin resins, (2) polystyrene resins, (3) acrylic resins, (4) polyvinyl acetate and the derivatives, (5) polyamide resins, (6) polyester resins, (7) polycarbonate resins, (8) polyether resins (or acetal resins), and (9) other resins. These thermoplastic resins may be used individually or in combination.

The (1) polyolefin resin, for example, may be polyolefin resins such as polyethylene and polypropylene, and copolymer resins of olefins such as ethylene and propylene and other vinyl monomers, and the like. The copolymer resin of olefin and other vinyl monomers, for example, may be ethylene-vinyl acetate copolymer and ionomer resin, copolymer of acrylic acid and methacrylic acid. The derivatives of polyolefin resin may be chlorinated polyethylene and chlorosulfonated polyethylene, and the like.

The (2) polystyrene resin, for example, may be polystyrene resin, styrene-isobutylene copolymer, acrylonitrile-styrene copolymer (AS resin), acrylonitrile-butadiene-styrene copolymer (ABS resin), and polystyrene-maleic anhydride resin, and the like.

The (3) acrylic resin, for example, may be polyacrylic acid or its esters, polymethacrylic acid or its esters, polyacrylonitrile, and polyacrylamide, and the like. The polyacrylic acid esters and polymethacrylic acid esters differ greatly in properties according to the type of ester group. Also, they may be copolymer with other monomers (for example, acrylic acid, methacrylic acid, styrene, and vinyl acetate). The polyacrylonitrile is often used as a copolymer of the above-mentioned AS resin and ABS resin rather than as a polymer.

The (4) poly vinyl acetate or its derivatives, for example, may be poly vinyl acetate, polyvinyl alcohol obtained by saponificating poly vinyl acetate, and polyvinyl acetal resin obtained by reacting polyvinyl alcohol with aldehyde (for example, formaldehyde, acetaldehyde, and butyraldehyde).

The (5) polyamide resin is a polycondensation products of diamine and dihydric acid, and may be nylon 6 and nylon 66.

The (6) polyester resin is a polycondensation products of an acid and an alcohol and the properties of the polyester resin are largely varied depending on the type of the combination of an acid and an alcohol. Eamples of the polyester resin (6) include a versatile resin produced from an aromatic dibasic acid and a bifunctional alcohol, such as a polyethyleneterephthalate and a polybutylenephthalate, and the like.

The (7) polycarbonate resin is generally polycarbonate from bisphenol A and phosgene.

The (8) polyether resin (or acetal resin), for example, may be polyether resin such as polyethylene oxide and polypropylene oxide, and acetal resin such as polyoxymethylene obtained through ring-opening-polymerization, and the like.

The (9) other resins may be polyurethane resin obtained through additional-polymerization.

In addition, the thermoplastic resins may be incorporated with pigments or dyes such as brightener, conductive agent, fillers, titanium oxides, ultramarine, carbon black, and the like depending on the application.

Laminated Paper

The laminated paper is a paper may be formed by laminating various resins, such as rubber or polymer sheets or films, which may be referred to as laminating materials, on a substrate of a raw paper. Examples of the laminating materials include polyolefin resin, polyvinyl chloride resin, polyester resin, polystyrene resin, polymethacrylate resin, polycarbonate resin, polyamide resin, and triacetyl cellulose, and the like. These resins may be used alone, or in combination.

The polyolefin resin, generally, is often formed by using low density polyethylene resin, however, in order to increase the heat resistance of the support, it is preferable to use polypropylene, a blend of polypropylene and polyethylene, high density polyethylene, and a blend of high density polyethylene and low density polyethylene. From the point of cost and laminated properties, using the blend of high density polyethylene and low density polyethylene is the most preferable in particular.

The mixing ratio (mass ratio) of the high density polyethylene to the low density polyethylene is preferably 1/9 to 9/1, more preferably 2/8 to 8/2, and still more preferably 3/7 to 7/3. When thermoplastic resin layers are forming on both surfaces of the raw paper, the back surface of the raw paper, for example, is preferably formed by using high density polyethylene, or a blend of high density polyethylene and the low density polyethylene. The molecular mass of the polyethylene is not limited and may be selected depending on the applications, for example, the melt index for any one of the high density polyethylene and low density polyethylene is preferably between 11.0 g/10 min to 40 g/10 min, and comprises extrusion suitability.

Treatment giving white light reflecting property may performed on these sheets or films. Treatment method like this, for example, may be a method adding pigment such as titanium oxide into these sheets or films, and the like.

The thickness of the support is not limited and may be selected depending on the applications. It is preferably 25 μm to 300 μm, and more preferably 50 μm to 260 μm, and still more preferably 75 μm to 220 μm.

[Other Layers]

Examples of the other layers of the electrophotographic image-receiving sheet include a backing layer, a surface protective layer, an contact improving layer, an intermediate layer, an undercoat layer, a cushion layer, a charge controlling (inhibiting) layer, a reflecting layer, a tint-adjusting layer, a storage ability-improving layer, an anti-adhering layer, an anti-curling layer and a smoothing layer. These layers may be a single layer composition, or a laminated structure of two or more layers.

Backing Layer

The backing layer in the electrophotographic image-receiving sheet is preferably disposed on a surface of the support, which is the opposite of the surface on which the toner image-receiving layer is disposed, in order to confer back surface output compatibility, and to improve back surface output image quality, curl balance and conveyability within equipment.

There is no particular limitation on the color of the backing layer. However, if the electrophotographic image-receiving sheet of the invention is a double-sided output image-receiving sheet where an image is formed also on the back surface, it is preferred that the backing layer is also white. It is preferred that the whiteness and spectral reflectance are 85% or more, for both the front surface and the back surface.

To improve double-sided output compatibility, the backing layer may have an identical structure to that of the toner image-receiving layer. The backing layer may comprise the above-described various additives. Of these additives, matting agents and charge controlling agents are particularly suitable. The backing layer may be single layer composition, or a laminated structure of two or more layers.

Further, if releasing oil is used for the fixing roller and the like, to prevent offset during fixing, the backing layer may have oil absorbing properties.

Usually, the thickness of the backing layer is preferably 0.1 μm to 10 μm.

Surface Protective Layer

The surface protective layer may be disposed on the surface of the toner image-receiving layer to protect the surface of the electrophotographic image-receiving sheet, to improve storage ability to improve handling properties, to facilitate writing, and conveyability within an equipment, to confer anti-offset properties, and the like. The surface protective layer may have one layer, or two or more layers. In the surface protective layer, various thermoplastic resins or thermosetting resins may be used as a binder, and are preferably the same types of resins as those of the toner image-receiving layer. However, the thermodynamic properties and electrostatic properties are not necessarily identical to those of the toner image-receiving layer, and may be individually optimized.

The surface protective layer may comprise the various additives described above which can be used for producing the toner image-receiving layer. In particular, in addition to the releasing agents, the surface protective layer may include other additives, for example matting agents and the like. The matting agents may be any of these used in the related art.

From the viewpoint of image fixing properties, it is preferred that the outermost surface layer of the electrophotographic image-receiving sheet (which refers to, for example, the surface protective layer, if disposed) has good compatibility with the toner. Specifically, it is preferred that the contact angle with molten toner is for 0° to 40°.

Contact Improving Layer

In the electrophotographic image-receiving sheet, it is preferred to dispose a contact improving layer in order to improve the contact between the support and the toner image-receiving layer. The contact improving layer may contain the various additives described above. Among them, crosslinking agents are particularly preferred to be blended in the contact improving layer. Furthermore, to improve accepting properties to the toner, it is preferred that the electrophotographic image-receiving sheet further comprises a cushion layer between the contact improving layer and the toner image-receiving layer.

Intermediate Layer

An intermediate layer may for example be disposed between the support and the contact improvement layer, between the contact improvement layer and the cushion layer, between the cushion layer and the toner image-receiving layer, or between the toner image-receiving layer and the storage ability-improving layer. In the case of the electrophotographic image-receiving sheet comprising the support, the toner image-receiving layer and the intermediate layer, the intermediate layer may of course be disposed for example between the support and the toner image-receiving layer.

The thickness of the electrophotographic image-receiving sheet of the present invention is not limited and may be properly selected depending on the applications. The thickness is preferably from 50 μm to 550 μm, more preferably from 100 μm to 350 μm.

<Toner>

In the electrophotographic image-receiving sheet, the toner image-receiving layer receives toners during printing or copying.

The toner contains at least a binder resin and a colorant, but may contain releasing agents and other components, if necessary.

Binder Resin for Toner

The binder resin is not limited and may be properly selected from resins used usually for producing the toner depending on the applications. Examples of the binder resin include homo-polymers or copolymers produced by polymerizing or copolymerizing a vinyl monomer or two or more vinyl monomers selected from the group consisting of vinyl monomers, fro example styrenes, such as styrene and parachlorostyrene; vinyl esters, such as vinyl naphthalene, vinyl chloride, vinyl bromide, vinyl fluoride, vinyl acetate, vinyl propioniate, vinyl benzoate and vinyl butyrate; methylene fatty carboxylate esters, such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate and butyl methacrylate; vinyl nitriles, such as acrylonitrile, methacrylonitrile and acrylamide; vinyl ethers, such as vinyl methyl ether, vinyl ethyl ether and vinyl isobutyl ether; N-vinyl compounds, such as N-vinyl pyrrole, N-vinyl carbazole, N-vinyl indole and N-vinyl pyrrolidone; and vinyl carboxylic acids, such as methacrylic acid, acrylic acid and cinnamic acid. Examples of the binder resin include also various polyesters. The above-noted examples of the binder resin may be used in combination with various waxes.

Among these resins, a resin of the same type as that of the resin used for producing the toner image-receiving layer according to the present invention is preferably used.

Colorant for Toner

The colorant used for the toner is not limited and may be properly selected from colorants generally used in the art in the toner depending on the applications. Examples of the colorant include various pigments, such as carbon black, chrome yellow, hansa yellow, benzidine yellow, threne yellow, quinoline yellow, Permanent Orange GTR, Pyrazolone orange, vulcan orange, watchung red, permanent red, Brilliant Carmine 3B, Brilliant Carmine 6B, Du Pont Oil Red, Pyrazolone Red, Lithol Red, Rhodamine B lake, Lake Red C, Rose Bengal, aniline blue, ultra marine blue, chalco oil blue, methylene blue chloride, phthalocyanine blue, phthalocyanine green, malachite green oxalate; and various dyes, such as acridine dyes, xanthene dyes, azo dyes, benzoquinone dyes, azine dyes, anthraquinone dyes, indigo dyes, thioindigo dyes, dioxazine dyes, thiazine dyes, azomethine dyes, phthalocyanine dyes, aniline black dyes, polymethine dyes, triphenylmethane dyes, diphenylmethane dyes and thiazole dyes.

These colorants may be used alone or in combination, and the like.

The amount of the colorant is not limited and may be properly selected depending on the applications. The amount is preferably from 2% by mass to 8% by mass, based on the mass of the toner. When the amount of the colorant is less than 2% by mass, the coloring power of the toner may be weakened. On the other hand, when the amount is more than 8% by mass, the transparency of the toner may be impaired.

Releasing Agent for Toner

The releasing agent is not limited and may be properly selected from releasing agents generally used in the art depending on the applications. Examples of particularly effective releasing agent include a highly crystalline polyethylene wax having a relatively low molecular mass, a Fischer-Tropsch wax, a amide wax and polar wax containing nitrogen such as compounds having a urethane bond.

The polyethylene wax has a molecular mass of preferably 1,000 or less, more preferable 300 to 1,000.

The compound having a urethane bond is preferred in that even if the compound has a low molecular mass, the compound can maintain a solid state by a strong cohesive force of a polar group and such a compound having a high melting point for the molecular mass thereof can be produced. The compound has a molecular mass of preferably from 300 to 1,000. Examples of a combination of materials for producing the compound include a combination of diisocyanic acid compounds and monohydric alcohols, a combination of a monoisocyanic acid and a monohydric alcohol, a combination of dihydric alcohols and a monoisocyanic acid, a combination of trihydric alcohols and a monoisocyanic acid and a combination of triisocyanic acid compounds and monohydric alcohols, and the like. However, for preventing the molecular mass of the compound from becoming too large, a combination of a compound having a multiple functional group and another compound having a single functional group is preferred and it is important that the total amount of the functionality in a combination is always equivalent.

Examples of the monoisocyanic acid compounds include dodecyl isocyanate, phenyl isocyanate and derivatives thereof, naphthyl isocyanate, hexyl isocyanate, benzyl isocyanate, butyl isocyanate and allyl isocyanate, and the like.

Examples of the diisocyanic acid compounds include tolylene diisocyanate, 4,4′ diphenylmethane diisocyanate, toluene diisocyanate, 1,3-phenylene diisocyanate, hexamethylene diisocyanate, 4-methyl-m-phenylene diisocyanate and isophorone diisocyanate, and the like.

Examples of the monohydric alcohols include methanol, ethanol, propanol, butanol, pentanol, hexanol and heptanol, and the like.

Examples of the dihydric alcohols include various glycols, such as ethylene glycol, diethylene glycol, triethylene glycol and trimethylene glycol, and the like. Examples of the trihydric alcohols include trimethylol propane, triethylol propane and trimethanol ethane, and the like.

These urethane compounds, as an ordinary releasing agent, may be mixed with the resins or the colorants during kneading, and also used as a kneaded-crushed toner. Further, in a case of using for an emulsion polymerization cohesion melting toner, the urethane compounds may be dispersed in water together with an ionic surfactant, polymer acid or polymer electrolyte such as a polymer base, heated above the melting point, and converted to fine particles by applying an intense shear in a homogenizer or pressure discharge dispersion machine to manufacture a releasing agent particle dispersion of 1 μm or less, which can be used together with a resin particle dispersion, colorant dispersion, and the like.

Other Components for Toner

The toner may comprise other components, such an inner additives, a charge controlling agents and inorganic fine particles and the like. Examples of the internal additives include magnetic substances such as ferrite, magnetite, reduced iron; and metals such as cobalt, nickel and manganese; the alloys thereof; and the compounds containing these metals.

Examples of the charge controlling agent include various charge controlling agents used usually, such as a quaternary ammonium salt, a nigrosine compound, a dye comprising a complex of a metal such as aluminum, iron and chromium and a triphenylmethane pigments and the like. It is preferred that the charge controlling agents are difficultly dissolved in water, from the viewpoint of controlling the ion strength which affect the stability during the cohesion and melting, and reducing the pollution by the waste water.

Examples of the inorganic particles include any of the external additives for toner surfaces generally used, such as silica, alumina, titania, calcium carbonate, magnesium carbonate and tricalcium phosphate, and the like. These particles are preferably used in the form of a dispersion produced by dispersing the particles in an ionic surfactant, a polymer acid or a polymer base.

Further, the toner may comprise as an additive surfactants for the emulsion polymerization, the seed polymerization, the pigment dispersion, the resin particles dispersion, the releasing agent dispersion, the cohesion and stabilization thereof. Examples of the surfactant include an anionic surfactant, such as a sulfate ester surfactants, sulfonate ester surfactants, phosphate ester surfactants and soaps; cationic surfactants, such as amine salt surfactants and a quaternary ammonium salt surfactants. It is also effective that the above-exemplified surfactants are used in combination with nonionic surfactants, such as polyethylene glycol surfactants, alkylphenol ethylene oxide adduct surfactants and polyhydric alcohol surfactants. As dispersing units for dispersing the surfactant in the toner, a general unit, such as a rotary shearing type homogenizer; and a ball mill, a sand mill and a dyno mill, and the like, all of which contain the media may be used.

The toner may comprise optionally external additives. Examples of the external additives include inorganic particles and organic particles. Examples of the inorganic particles include particles of SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄ and MgSO₄, and the like. Examples of the organic particles include particles of a fatty acid and derivatives thereof; a metal salt of the above-noted fatty acid and derivatives thereof; and a resin, such as a fluorine resin, a polyethylene resin and an acrylic resin, and the like.

The average particle diameter of the above-noted particles is preferably from 0.01 μm to 5 μm, more preferably from 0.1 μm to 2 μm.

The manufacturing method of the toner is not limited and may be properly selected depending on the applications. However, it is preferred that the toner is produced according to a manufacturing method of the toner comprising (i) preparing a dispersion of cohesive particles of resins by forming cohesive particles in a dispersion of particle resins, (ii) forming attached particles by mixing the above-prepared dispersion of cohesive particles with a dispersion of fine particles, so that the fine particles attaches to the cohesive particles, thereby forming attached particles and (iii) forming toner particles by heating the attached particles to be melted.

Physical Properties of Toner

The toner has a volume average particle diameter of preferably from 0.5 μm to 10 μm.

When the volume average particle diameter of the toner is too small, handling properties of the toner, such as replenish properties, cleaning properties and fluidity, may be affected adversely and the productivity of the particles may be lowered. On the other hand, when the volume average particle diameter of the toner is too large, the quality and resolution of the image due to graininess and transfer may be affected adversely.

It is preferred that the toner satisfies the above-noted range of a volume average particle diameter and has a distribution index of the volume average particle diameter (GSDv) of 1.3 or less.

The ratio (GSDv/GSDn) of the distribution index of the volume average particle diameter (GSDv) to the distribution index of the number average particle diameter (GSDn) is preferably 0.95 or more.

It is preferred that the toner satisfies the above-noted range of the volume average particle diameter and an average of the shape factor is preferably 1.00 to 1.50 which is calculated by the following equation:
Shape factor=(π×L²)/(4×S)
where “L” represents the maximum length of the toner particles and “S” represents the projected area of the toner particles.

When the toner satisfies the above-noted conditions, an effect on the image quality, such as graininess and resolution particularly can be obtained and moreover, dropout or blur which may accompany with the transfer is difficultly caused. Further, in this case, the handling properties of the toner may be difficultly affected adversely, even if the average particle diameter of the toner is not small.

From the viewpoint of improving the image quality and preventing the offset during the image-fixing, it is appropriate that the toner has storage elasticity modulus G′ (as measured at a circular frequency of 10 rad/sec) of 1×10² Pa to 1×10⁵ Pa at 150° C.

(Image-Forming Method)

The image-forming method according to the present invention comprises forming the toner image and fixing a toner image followed by smoothing a surface of a toner image, and other steps depending on requirements.

Forming a Toner Image

The forming a toner image is the step of forming a toner image on the electrophotographic image-receiving sheet according to the present invention.

The step of forming a toner image is not limited and may be properly selected depending on the applications, as long as the toner image can be formed on the electrophotographic image-receiving sheet. The method generally used in the electrophotography may be used, for example, a direct transferring method in which the toner image formed on the developing roller is directly transferred to the electrophotographic image-receiving sheet, and an intermediate transfer belt method in which the toner image formed on the developing roller is primarily transferred to the intermediate transfer belt and the primary-transferred image is transferred to the electrophotographic image-receiving sheet. Among these methods, from the viewpoint of environmental stability and enhancing the image quality, the intermediate transfer belt method may be preferably used.

Fixing a Toner Image Followed by Smoothing the Surface of the Toner Image

Fixing a toner image followed by smoothing the surface of the toner image is the step of fixing a toner image formed by the forming the toner image, and then smoothing the surface of the toner image. The fixing the toner image on the electrophotographic image receiving sheet, followed by smoothing the surface of the toner image comprises heating, pressurizing and cooling and the electrophotographic image-receiving sheet by using an apparatus equipped with a heating and pressurizing member, a belt member and a cooling device.

The apparatus for fixing and smoothing a surface of a toner image comprises a heating and pressurizing member, a belt member, a cooling device, a cooling and separating part and the other members depending on requirements.

The heating and pressurizing member is not limited and may be properly selected depending on the applications. Examples of the heating-pressurizing member include a pair of heating rollers and a combination of a heating roller and a pressurizing roller.

The cooling device is not limited and may be properly selected depending on the applications. Examples of the cooling device include a device capable of blowing cold air and capable of controlling the cooling temperature and a heatsink, are used.

The cooling and separating part is not limited and may be properly selected depending on the applications. Examples of the cooling and separating part include a section which is near the tension roller on which the electrophotographic image-receiving sheet is separated from the belt by its own stiffness or rigidity.

In order to contact the toner image with a heating and pressurizing member of the apparatus for fixing and smoothing a surface of a toner image, preferably, the toner image is pressed tightly. The pressurizing method is not limited and may be properly selected depending on the applications. However, a nip pressure may be preferably used. The nip pressure is preferably 1 kgf/cm² to 100 kgf/cm², more preferably 5 kgf/cm² to 30 kgf/cm², in terms of forming an image excellent in water resistance and surface smoothness and having an excellent glossiness. The heating temperature in the heating and pressurizing member is the temperature which is more than the softening point of the polymer for the toner image-receiving layer and varies depending on the type of the polymer for the toner image-receiving layer. The heating temperature is usually preferably 80° C. to 200° C. The cooling temperature in the cooling device is preferably 80° C. or lower where the toner image-receiving layer is satisfactorily cured, more preferably is 20° C. to 80° C.

The belt member comprises a heat-resistant support film and a releasing layer disposed on the support film.

The material for the support film is not limited and may be properly selected depending on the applications, as long as the material has a heat resistance. Examples of the material include polyimide (PI), polyethylene naphthalate (PEN), polyethylene terephthalate (PET), polyetheretherketone (PEEK), polyethersulfone (PES), polyetherimide (PEI) and polyparabanic acid (PPA) and the like.

The releasing layer preferably comprises at least one kind selected from the group consisting of silicone rubber, fluorine rubber, fluorocarbon siloxane rubber, silicone resins and fluorine resins. Among them, the following aspects i) and ii) are preferred: i) a fluorocarbon siloxane rubber layer disposed on the surface of the belt member; ii) a silicone rubber layer disposed on the surface of the belt member and a fluorocarbon siloxane rubber layer disposed on the surface of the silicone rubber layer.

The fluorocarbon siloxane rubber has preferably in the backbone chain thereof at least one of a perfluoroalkyl ether group and a perfluoroalkyl group.

The fluorocarbon siloxane rubber is preferably a cured product of a fluorocarbon siloxane rubber composition comprising the following components (A) to (D):

(A) a fluorocarbon polymer comprising mainly a fluorocarbon siloxane represented by the following formula (1) and having an unsaturated fatty hydrocarbon group, (B) at least one of organopolysiloxane and fluorocarbon siloxane which has two or more ≡SiH groups in a molecule, wherein the amount of a ≡SiH group is from one to four times (in mole) the amount of the unsaturated fatty hydrocarbon group in the above-mentioned fluorocarbon siloxane rubber composition, (C) a filler, and (D) an effective amount of catalyst.

The fluorocarbon polymer as the component (A) comprises mainly a fluorocarbon siloxane containing a repetition unit represented by the following formula (1) and contains an unsaturated fatty hydrocarbon group.

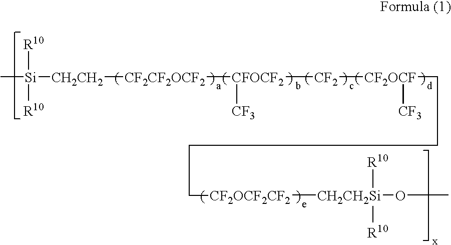

In formula (1), R¹⁰ represents the unsubstituted or substituted monovalent hydrocarbon group containing 1 to 8 carbon atoms, preferably an alkyl group containing 1 to 8 carbon atoms or an alkenyl group containing 2 to 3 carbon atoms, and particularly preferably a methyl group.

In formula (1), “a” and “e” in the formula are respectively the integer of 0 or 1, “b” and “d” are respectively the integer of 1 to 4 and “c” is the integer of 0 to 8; “x” in the formula is preferably the integer of 1 or more, more preferably the integer of 10 to 30.

Examples of the component (A) include the compound represented by the following formula (2):

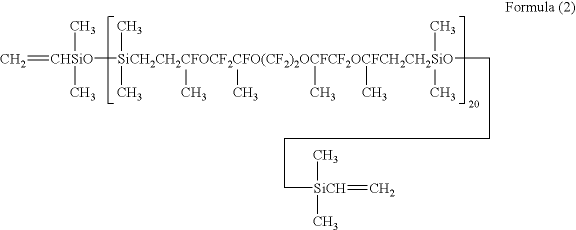

With respect to the component (B), examples of the organopolysiloxane having ≡SiH groups include an organohydrogen polysiloxane having in the molecule at least two hydrogen atoms bonded to a silicon atom.

In the fluorocarbon siloxane rubber composition, when the fluorocarbon polymer as the component (A) has an unsaturated fatty hydrocarbon group, as a curing agent, the above-mentioned organohydrogen polysiloxane is preferably used. In other words, the cured product is formed by an addition reaction between the unsaturated fatty hydrocarbon group of the fluorocarbon siloxane and a hydrogen atom bonded to a silicon atom in the organohydrogen polysiloxane.

Examples of the organohydrogen polysiloxane include various organohydrogen polysiloxanes used for curing a silicone rubber composition which is cured by an addition reaction.

The amount of the organohydrogen polysiloxane is an amount by which the number of ≡SiH group in the organohydrogen polysiloxane relative to one unsaturated fatty hydrocarbon group in the fluorocarbon siloxane of the component (A) is preferably at least one, most preferably from 1 to 5.

As for the fluorocarbon containing ≡SiH groups, R¹⁰ in the formula (1), as one unit or entire of the compound, is a dialkylhydrogen siloxy group, the terminal group is a ≡SiH group, such as a dialkylhydrogen siloxy group or a silyl group. Such a preferred fluorocarbon siloxane may be represented by the following formula (3).

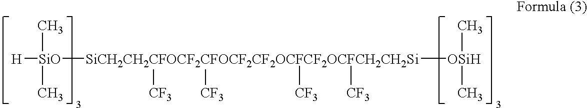

As the filler which is the component (C), various fillers used for a usual silicone rubber composition may be used. Examples of the fillers include a reinforcing filler, such as mist silica, precipitated silica, carbon powder, titanium dioxide, aluminum oxide, quartz powder, talc, sericite and bentonite; and fiber filler, such as asbesto, glass fiber, and organic fiber, and the like.

Examples of the catalyst as the component (D) include an element belonging to Group VIII in the Periodic Table and a compound thereof, such as chloroplatinic acid; alcohol-modified chloroplatinic acid; a complex of chloroplatinic acid with an olefin; platinum black and palladium which are respectively supported on a carrier, such as alumina, silica and carbon; a complex of rhodium with an olefin, chlorotris(triphenylphosphine) rhodium (Wilkinson catalyst) and rhodium (III) acetyl acetonate, which are conventional catalysts for the addition reaction. It is preferred that these complexes are dissolved in a solvent, such as an alcohol compound, an ether compound or a hydrocarbon compound to be used.

The fluorocarbon siloxane rubber composition is not limited and may be properly selected depending on the applications, and optionally may comprise various additives. Examples of the various additives include a dispersing agent, such as a diphenylsilane diol, a low polymer of dimethyl polysiloxane in which the terminal of the molecule chain is blocked with a hydroxyl group, and a hexamethyl disilazane; a heat resistance improver, such as ferrous oxide, ferric oxide, cerium oxide and iron octylate; and a colorant, such as a pigment.

The belt member can be obtained by coating a heat-resistant support film with the fluorocarbon siloxane rubber composition and by curing the resultant coated support film by the heating. Further optionally, the belt member can be obtained by coating the support film with a coating liquid prepared by diluting the fluorocarbon siloxane rubber composition with a solvent, such as m-xylene hexafluoride and benzotrifluoride, according to a general coating method, such as spray coating, dip coating and knife coating. The heating-curing temperature and time may be properly selected from the ranges of from 100° C. to 500° C. (temperature) and from 5 seconds to 5 hours (time) depending on the type of the support film and the manufacturing method of the belt member.

The thickness of the releasing layer disposed on the surface of the heat-resistant support film is not limited and may be properly selected depending on the applications. For obtaining an advantageous image fixing properties by suppressing the release characteristics of the toner or by preventing the off-set of the toner component, the thickness is preferably from 1 μm to 200 μm, more preferably from 5 μm to 150 μm.

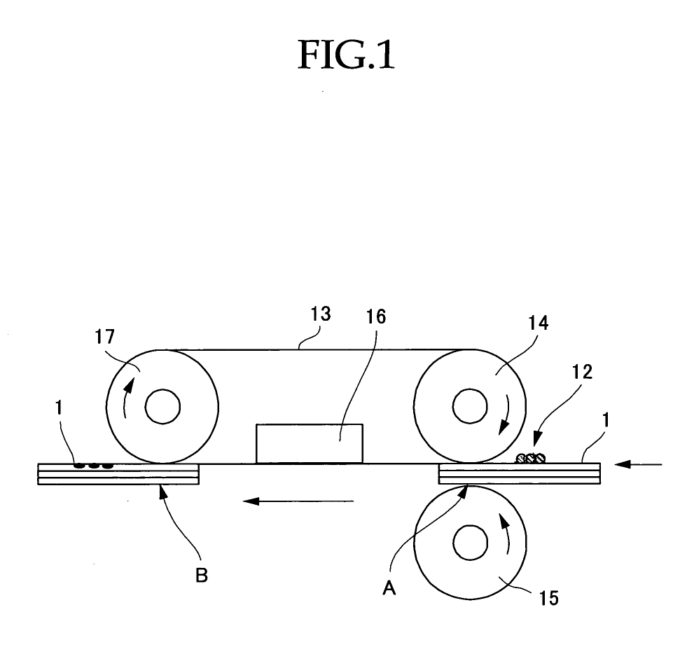

Here, with respect to an example of a belt fixing device of the image forming apparatus of the present invention, explanations are given in detail with referring to FIG. 1.

First, by an image-forming apparatus (not shown), the toner 12 is transferred to the electrophotographic image-receiving sheet 1. The electrophotographic image-receiving sheet 1 to which the toner 12 is adhered is conveyed to the point A by a conveying unit (not shown) and passes through between the heating roller 14 and the pressurizing roller 15 to be heated and pressed at the temperature (fixing temperature) and under the pressure, wherein the temperature and pressure are enough high to soften the toner image-receiving layer of the electrophotographic image-receiving sheet 1 and the toner 12.

Here, the fixing temperature means a temperature of the surface of the toner image-receiving layer measured in a nip part between the heating roller 14 and the pressurizing roller 15 at the point A and is preferably from 80° C. to 190° C., more preferably from 100° C. to 170° C. The pressure means a pressure of the surface of the toner image-receiving layer measured also in a nip part between the heating roller 14 and the pressurizing roller 15 at the point A and is preferably from 1 kgf/cm² to 10 kgf/cm², more preferably from 2 kgf/cm² to 7 kgf/cm².

The electrophotographic image-receiving sheet 1 which is heated and pressured is, next, conveyed by the fixing belt 13 to the cooling device 16 and during the conveyance of the electrophotographic image-receiving sheet 1, in the electrophotographic image-receiving sheet 1, a releasing agent (not shown) dispersed in the toner image-receiving layer is satisfactorily heated and molten. The molten releasing agent is gathered to the surface of the toner image-receiving layer, so that in the surface of the toner image-receiving layer, a layer (film) of the releasing agent is formed. Then, image-receiving sheet 1 conveyed to cooling device 16 by the fixing belt 13 is cooled to a temperature which is, for example, not higher than either the softening point of a binder resin used for producing the polymer of the toner image-receiving layer or the toner, or the temperature which is lower than the glass transition point of the above-noted binder resin plus 10° C., which is preferably from 20° C. to 80° C., more preferably at room temperature (25° C.). Thus, the layer (film) of the releasing agent formed on the surface of the toner image-receiving layer is cooled and cured, thereby formed the releasing agent layer.

Cooled image-receiving sheet 1 is further conveyed to the point B by fixing belt 13, and fixing belt 13 which moves over tension roller 17. At the point B, electrophotographic image-receiving sheet 1 is separated from fixing belt 13. Preferably the diameter of tension roller 17 is set so small that electrophotographic image-receiving sheet 1 is separated from fixing belt 13 by its own stiffness or rigidity of electrophotographic image-receiving sheet 1.

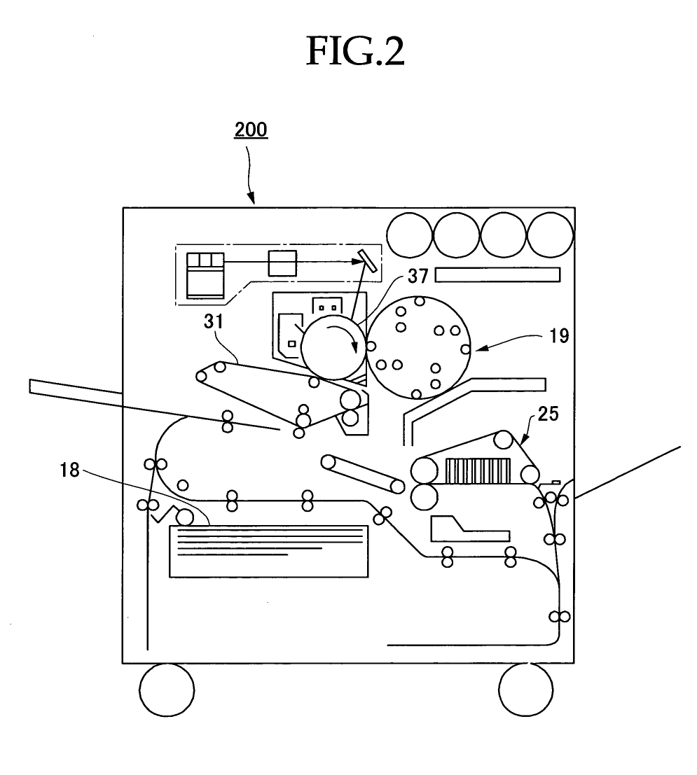

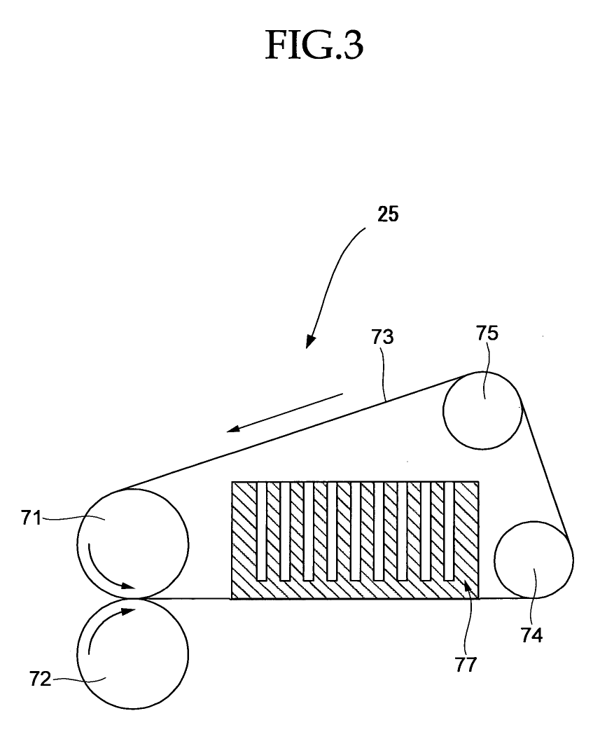

The apparatus for fixing and smoothing a surface of a toner image shown in FIG. 3 may modified to use as a fixing part of an image-forming apparatus, full-color laser printer DCC-500 by Fuji Xerox Co., Ltd. shown in FIG. 2.

In FIG. 2, 200 denotes the image-forming apparatus, 37 denotes the photoconductive drum, 19 denotes the developing device, 31 denotes the intermediate transfer belt, 18 denotes the electrophotographic image-receiving sheet, and 25 denotes the fixing part (the apparatus for fixing and smoothing a surface of a toner image).

FIG. 3 shows fixing part 25 (the apparatus for fixing and smoothing a surface of a toner image) which is installed inside image-forming apparatus 200 shown in FIG. 2.

As shown in FIG. 3, the apparatus for fixing and smoothing a surface of a toner image 25 comprises heat roller 71, separating roller 74 containing heat roller 71, endless belt 73 supported rotatably by the tension roller 75 and pressurizing roller 72 contacted to the heat roller 71 through the endless belt 73.

Cooling heatsink 77, which forcibly cools endless belt 73, is arranged inside endless belt 73 between heat roller 71 and separating roller 74. Cooling heatsink 77 constitutes the cooling and sheet-conveying part for cooling and conveying electrophotographic image-receiving sheet 18.

In apparatus for fixing and smoothing a surface of a toner image 25 as shown in FIG. 3, the electrophotographic image-receiving sheet on which a color toner image transferred and fixed on the surface thereof is introduced in a contact part or a nip part which is made by pressurizing roller 72 contacting heat roller 71 by pressing through endless belt 73, while the color toner image on the image-receiving sheet faces heat roller 71. While the electrophotographic image-receiving sheet passes through the contact part between heat roller 71 and pressurizing roller 72, the color toner image is heated and melted so as to be fixed on the electrophotographic image-receiving sheet.

At the contact part between heat roller 71 and pressurizing roller 72, the toner is heated approximately at 120° C. to 130° C. to be melted, and then the color toner image is fixed on the image-receiving layer on the electrophotographic image-receiving sheet. The electrophotographic image-receiving sheet is conveyed with endless belt 73, while the image-receiving layer on the surface of the electrophotographic image-receiving sheet is closely contacted to the surface of endless belt 73. Endless belt 73 is forcibly cooled by cooling heatsink 77, the color toner image and the image receiving layer is cured by cooling, followed by separating from separating roller 74 by its own stiffness or rigidity of the electrophotographic image-receiving sheet 1.

From the surface of endless belt 73, after the separating, a residual toner is removed by a cleaner (not shown) and prepared for the next fixing a toner image followed by smoothing the surface of the toner image.

By using the image-forming method according to the present invention, even if an image-forming apparatus equipped without fixing oil is used, the separation of the electrophotographic image-receiving sheet or the toner, or the offset of the electrophotographic image-receiving sheet and the toner components can be prevented, a stable feeding of the image-receiving sheet can be attained, film forming is increased and excellent surface condition and glossiness, a high quality image similar to that of a silver salt photography can be obtained.

The present invention will be described in further detail with reference to several examples and the comparative examples below, which are not intended to limit the scope of the present invention. As for the units below, all percentage and parts are by mass unless indicated otherwise.

### EXAMPLES

<Preparation of Support>

High quality paper having a basic weight of 160 g/m² was used as raw paper. By coating the blended product of High density polyethylene (HDPE) and low density polyethylene (LDPE) and on the back surface of the raw paper by an extrusion coating method at fluxing temperature of 310° C., thereby disposed a back surface polyethylene layer of 15 μm thick. The mass ratio of High density polyethylene (HDPE) to low density polyethylene (LDPE), HDPE/LDPE, is 7/3. On the other hand, the opposite surface of the polyethylene layer in the raw paper, which is the front surface thereof, low density polyethylene (LDPE) was coated by an extrusion coating method at fluxing temperature of 310° C., thereby disposed a front surface polyethylene layer of 31.7 μm thick.

<Preparing of Titanium Dioxide Dispersion Liquid>

The following components were mixed and dispersed by NBK-2 by Nissei Corporation to prepare the titanium dioxide dispersion liquid.

| | | |
|---|---|---|
| Titanium dioxide: R780-2¹*⁾ | 48 | parts by mass |
| Polyvinyl alcohol: PVA 205C (by Kuraray Co.) | 40 | parts by mass |
| Surfactant: DEMOL EP (by Kao Corporation) | 0.6 | part by mass |
| Deionized water | 31.6 | parts by mass |

¹*⁾by Ishihara Sangyo Kaisha, Ltd.

### Example 1

The following components were mixed in order to prepare a coating liquid for the undercoat layer. The front surface of the support was coated with the prepared coating liquid using a bar coater so that the amount of dried coated resin was 10 g/m² or the thickness was 15 μm. Then, the undercoat layer was dried at 90° C. for 5 minutes.

<Composition of Undercoat Layer Coating Liquid>

| | | |
|---|---|---|
| Urethane resin aqueous dispersion: Takelac | 250 | parts by mass |
| W6020¹*⁾ | | |
| Hollow particle aqueous dispersion²*⁾ | 566 | parts by mass |
| Polyethyleneoxide: Alcox R1000³*⁾ | 4 | parts by mass |
| Anionic surfactant: Rapisol A90⁴*) | 1.6 | parts by mass |
| Water | 94.4 | parts by mass |

¹*⁾by Mitsui Takeda Chemicals, Inc.
²*⁾Lowpaque HP1055 (by Zeon Corporation, void rate of 55% by volume, volume-average particle diameter of 1 μm)
³*⁾by Meisei Chemicals Co.
⁴*⁾by Nippon Oil & Fats Co., Ltd.

A coating liquid for the toner image-receiving layer was prepared by blending the following components. The surface of the undercoat layer was coated with the prepared coating liquid for the toner image-receiving layer using a bar coater, so that the amount of the dried coated resin was 5.5 g/m² or the thickness was 7 μm. Then, the toner image-receiving layer was dried at 90° C. for 3 minutes, thereby produced an electrophotographic image-receiving sheet.

<Composition of Coating Liquid for Toner Image-Receiving Layer>

| | | |
|---|---|---|
| Polyester resin aqueous dispersion: KA7276C¹*⁾ | 200 | parts by mass |
| Water | 128.7 | parts by mass |
| The above-mentioned Titanium dioxide | 15.5 | parts by mass |
| dispersion: R780-2²*⁾ | | |
| Carnauba wax dispersion: Serozol 524³*⁾ | 10 | parts by mass |
| Polyethyleneoxide: Alcox R1000⁴*⁾ | 4.8 | parts by mass |
| Anionic surfactant: Rapisol A90⁵*⁾ | 1.5 | parts by mass |
| Matting agent: XX08S (by Sekisui Chemical | 1.8 | parts by mass |
| Co. Ltd.) | | |

¹*⁾by Unitika Ltd. number-average molecular mass of 6,000, solid content: 35% by mass
²*⁾by Ishihara Sangyo Kaisha Co.
³*⁾by Chukyo Yushi Co., Ltd.
⁴*⁾by Meisei Chemical Industries Co., Ltd.
⁵*⁾by Nippon Oil & Fats Co., Ltd.

### Example 2

An electrophotographic image-receiving sheet was produced in the same way as Example 1, except that Lowpaque HP433J (by Zeon Corporation, void rate of 33% by volume, volume-average particle diameter of 0.5 μm) was used as the hollow particle aqueous dispersion for the coating liquid for the undercoat layer.

### Example 3

The electrophotographic image-receiving sheet was produced in the same way as Example 1, except that SX866 (by JSR Corporation, void rate of 33% by volume, volume-average particle diameter of 0.5 μm) was used as the hollow particle aqueous dispersion for the coating liquid for the undercoat layer, and the acrylic resins of XE240 (by Seiko Polymer Corporation) and RDX7325 (by Johnson Polymer Corporation) which were mixed in mass ratio of 5 to 5.

### Example 4

The electrophotographic image-receiving sheet was produced in the same way as Example 1, except that 1 part by mass of Lowpaque HP1055 (by Zeon Corporation, void rate of 55% by volume, volume-average particle diameter of 1 μm) was used as the hollow particle aqueous dispersion for the coating liquid for the toner image-receiving layer.

### Example 5

The fine gas phase silica particles and deionized water in the following composition were mixed and dispersed at rotating speeds of 10,000 rpm for 20 minutes by a high-speed rotation colloid mill, Clearmix, by M Technique Co., Ltd., thereby prepared a dispersion liquid of inorganic fine particles. Polydimethyldiallyl ammonium chloride, polyvinyl alcohol, boric acid, polyoxyethylenelaurylether, and the solution containing deionized water in the following composition were added to the dispersion liquid of inorganic fine particles, which was further mixed at rotating speeds of 10,000 rpm for 20 minutes, thereby prepared a coating liquid for porous layer A.

<Composition of Coating Liquid for Porous Layer A>

| | | |
|---|---|---|
| Fine gas phase silica particles¹*⁾ | 10.0 | parts by mass |
| Deionized water | 51.7 | parts by mass |
| Plydimethyldiallyl ammonium chloride²*⁾ | 0.49 | part by mass |
| Polyvinyl alcohol (aqueous resin): PVA124³*⁾ | 27.8 | parts by mass |
| Boric acid (crosslinker) | 0.4 | part by mass |
| Polyoxyethylenelaurylether (surfactant)⁴*⁾ | 1.2 | parts by mass |
| Deionized water | 33.0 | parts by mass |

¹*⁾Inorganic fine particles: Reolosil QS30 (by Tokuyama Corp., average-primary particle diameter of 7 nm
²*⁾Dispersing agent: Chaleur DC902P by Dai-Ichi Kogyo Seiyaku Co., Ltd.
³*⁾by Kuraray Co., saponification degree of 98.5%, polymerization degree of 2400
⁴*⁾EMULGEN 109P (by Kao Corporation, solution of 10% by mass, HLB value of 13.6)

<Composition of Coating Liquid for Porous Layer B>

| | | |
|---|---|---|
| Boric acid (crosslinker) | 0.65 | part by mass |
| Polyallylamine (mordant): PAA-10C¹*⁾ | 25 | parts by mass |
| Deionized water | 59.7 | parts by mass |
| Ammonium chloride (control agent of surface pH) | 0.8 | part by mass |
| Polyoxyethylenelaurylether (surfactant)²*⁾ | 10 | parts by mass |
| Fluoro surfactant: MEGAFAC F1405³*⁾ | 2.0 | parts by mass |

¹*⁾by Nittobo Co., Ltd., solution of 10% by mass
²*⁾EMULGEN 109P (by Kao Corporation, solution of 10% by mass, HLB value of 13.6)
³*⁾by Dainippon Ink and Chemicals, Inc., solution of 10% by mass

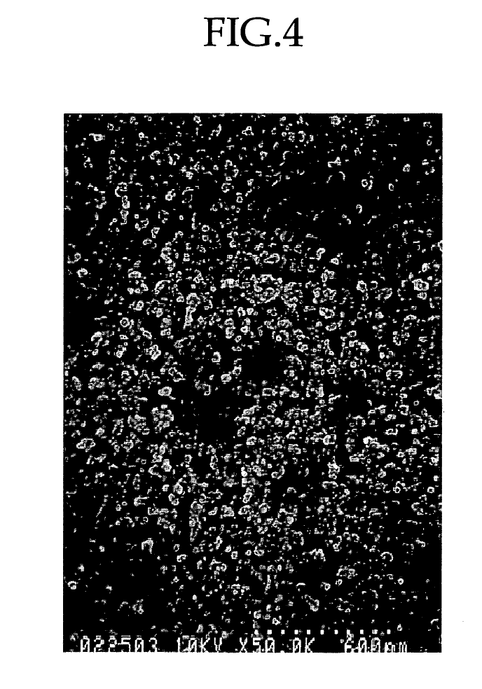

After corona discharge was applied on the front surface of the support, the front surface of the support was coated with the coating liquid for porous layer A in the amount of 100 ml/m² by an extrusion dye coater (coating step). Then the coated layer was dried at 80° C. with wind velocity of 3 m/second to 8 m/second by a hot air dryer in the constant rate of drying, so that the solid content of the coated layer was 20% by mass. Shortly after the above process, the coated layer was soaked in the coating liquid for porous layer B containing the above-mentioned composition for 30 seconds to be coated on the coated layer in the amount of 10 g/m². Further, the coated layer was dried at 80° C. for 10 minutes (drying step). Thereby, a porous polymer layer having the film thickness of 16 μm after drying. The electron microscopic picture of the obtained porous polymer layer is shown in FIG. 4. The pore size of the porous polymer layers is 30 nm to 50 nm and the void rate is 60% by volume.

Next, the toner image-receiving layer was formed on the porous polymer layer in the same way as Example 1, and then the electrophotographic image-receiving sheet described in Example 5 was produced.

### Example 6

An electrophotographic image-receiving sheet was produced in the same way as Example 1, except that the hollow particle aqueous dispersion was excluded from the coating liquid for the undercoat layer and 1 part by mass of Lowpaque HP1055 (by Zeon Corporation, void rate of 55% by volume, volume-average particle diameter of 1 μm) was added as the hollow particle aqueous dispersion for the coating liquid for the toner-image receiving layer.

### Comparative Example 1

A electrophotographic image-receiving sheet was prepared in the same way as Example 1, except that the hollow particle aqueous dispersion was excluded from the coating liquid for the undercoat layer.

### Comparative Example 2

The following components were mixed in order to prepare a coating liquid for toner image-receiving layer. Similar to Example 1, the front surface of the support was coated with the prepared coating liquid for the toner image-receiving layer using a bar coater so that the amount of dried coated resin was 10 g/m² or the thickness was 16 μm. Then, the undercoat layer was dried at 90° C. for 5 minutes, thereby prepared an electrophotographic image-receiving sheet.

<Composition of the Coating Liquid for the Toner Image-Receiving Layer>

| | | |
|---|---|---|
| Polyester resin aqueous dispersion: KA7276C¹*⁾ | 200 | parts by mass |
| Water | 128.7 | parts by mass |
| The above-mentioned Titanium dioxide | 15.5 | parts by mass |
| dispersion²*⁾ | | |
| Carnauba wax dispersion: Serozol 524³*⁾ | 10 | parts by mass |
| Polyethyleneoxide: Alcox R1000⁴*⁾ | 4.8 | parts by mass |
| Hollow particle aqueous dispersion⁵*⁾ | 130 | parts by mass |
| Matting agent: XX08S (by Sekisui Chemicals | 1.8 | parts by mass |
| Co.) | | |

¹*⁾by Unitika Ltd., number-average molecular mass of 6,000, solid content of 30% by mass
²*⁾by Ishihara Sangyo Kaisha Co.
³*⁾by Chukyo Yushi Co., Ltd.
⁴*⁾by Meisei Chemicals Co.
⁵*⁾Lowpaque HP1055 (by Zeon Corporation, void rate of 55% by volume, volume-average particle diameter of 1 μm)

<Image Forming>

Then, the image forming was performed on the obtained electrophotographic image-receiving sheet, in which the even image of 18 cm four-way at the highest density of black color was printed on the obtained electrophotographic image-receiving sheet and then fixed with the printed surface thereof facing up, in the following condition by means of the image forming apparatus DocuCentre Color 500CP by Fuji Xerox Co., Ltd. as shown in FIG. 2 whose fixing part is modified to the apparatus for fixing and smoothing a surface of a toner image shown in FIG. 3 under the atmosphere of 25° C. and 50% relative humidity.

Belt

Support of the belt: polyimide (PI) film, width of 50 cm, thickness of 80 μm

Releasing layer material of the belt: SIFEL610, a fluorocarbon siloxane rubber precursor (by Shin-Etsu Chemical Co., Ltd.) was vulcanized to form a fluorocarbon siloxane rubber of 50 μm thick.

Heating and Pressurizing

Temperature of heating roller: 120° C.
Nip pressure: 130N/cm²
   Cooling
Cooler: heatsink length of 80 mm
Conveyance Speed: 20 mm/second
Temperature: 70° C.
   <Evaluation of Cracking Resistance>

The formed black solid image on the sheet was cut into a size of 3 cm by 10 cm, and then left under the condition where the temperature of 10° C. and a relative humidity of 15% for 16 hours. The obtained sample was wound around a bar having a diameter of 20 mm and the crack caused on the surface of the sample was evaluated according to the following standard. The results are shown in Table 3.

[Evaluation Standard]

A: Unable to observe cracks visually
B: Able to observe cracks
   <Evaluation of Blister>

The temperature was determined at which blisters or bubbles were generated on the surface of the image, while raising the heating temperature of the apparatus for fixing and smoothing a surface of a toner image. The results are shown in Table 3.

<Evaluation of Voids>

The temperature was determined at which voids or unfixing are generated in the border between an image part and a non-image part, while lowering the heating temperature of the apparatus for fixing and smoothing a surface of a toner image. The results are shown in Table 3.

<Evaluation of Latitude>

From the results of the evaluations of blisters and voids, the latitude of the fixing temperatures were evaluated according to the following standard. The results are shown in Table 3.

[Evaluation Standard]

A: Latitudes of over 10° C. is assured.

B: Latitudes of over 10° C. is not assured.

TABLE 2

| | Cracking | | | Latitude of Fixing |
|---|---|---|---|---|
| | resistance | Blister | Voids | Temperature |
| Example 1 | A | 130° C. | 110° C. | A |
| Example 2 | A | 130° C. | 115° C. | A |
| Example 3 | A | 130° C. | 115° C. | A |
| Example 4 | A | 130° C. | 110° C. | A |
| Example 5 | A | 130° C. | 110° C. | A |
| Example 6 | A | 130° C. | 115° C. | A |
| Comp. Example 1 | A | 125° C. | 120° C. | B |
| Comp. Example 2 | B | 125° C. | 115° C. | B |

The electrophotographic image-receiving sheet according to the present invention are excellent in both cracking resistance and image fixing properties, and can form high quality images, thus the sheet may be appropriately used for high speed fixing image-forming apparatuses.

By using the image-forming method according to the present invention, even if an image-forming apparatus equipped without fixing oil is used, the separation of the electrophotographic image-receiving sheet or the toner, or the offset in the electrophotographic image-receiving sheet and the toner components can be prevented, a stable feeding of the image-receiving sheet can be attained, an electrophotographic image-receiving sheet having an excellent cracking resistance, image fixing properties and a high quality image similar to that of a silver salt photography can be obtained.

What is claimed is:

1. An electrophotographic image-receiving sheet, comprising:
a support, and
at least two polymer layers disposed on the support,
wherein at least one of the polymer layers have voids.

2. The electrophotographic image-receiving sheet according to claim 1, wherein the voids are formed in the polymer layers except an outermost polymer layer.

3. The electrophotographic image-receiving sheet according to claim 1, wherein the support comprises a raw paper and polyolefin resin layers which are disposed on both surfaces of the raw paper.

4. The electrophotographic image-receiving sheet according to claim 1, wherein the polymer layer comprise an undercoat layer and a toner image-receiving layer, and the toner image-receiving layer is disposed on the undercoat layer.

5. The electrophotographic image-receiving sheet according to claim 1, wherein the voids are formed by hollow particles comprised in the polymer layers.

6. The electrophotographic image-receiving sheet according to claim 1, wherein the voids are formed by fine particles comprised in the polymer layers.

7. The electrophotographic image-receiving sheet according to claim 2, wherein the content of the voids in the polymer layers except the outermost polymer layer is preferably 30% by volume or more.

8. The electrophotographic image-receiving sheet according to claim 2, wherein the outermost polymer layer comprises an aqueous polymer.

9. The electrophotographic image-receiving sheet according to claim 8, wherein the aqueous polymer comprises a water-dispersible polyester emulsion.

10. The electrophotographic image-receiving sheet according to claim 9, wherein the water-dispersible polyester emulsion is self-dispersible.

11. The electrophotographic image-receiving sheet according to claim 10, wherein the self-dispersible polyester emulsions satisfies the following characteristics (1) to (4):
(1) the number-average molecular mass (Mn) is 5,000 to 10,000;
(2) the molecular mass distribution, Mw/Mn (mass-average molecular mass/number-average molecular mass), is 4 or less;
(3) the glass transition temperature (Tg) is 40° C. to 100° C.; and
(4) the volume average particle diameter is 20 nm to 200 nm.

12. An image-forming method comprising:
forming a toner image on an electrophotographic image-receiving sheet, and
fixing the toner image on the electrophotographic image-receiving sheet, followed by smoothing the surface of the toner image,
wherein the electrophotographic image-receiving sheet comprising a support, and at least two polymer layers disposed on the support,
wherein at least one of the polymer layers comprises voids.

13. The image-forming method according to claim 12, wherein the voids are comprised in the polymer layers except an outermost layer.

14. The image-forming method according to claim 12, wherein the fixing the toner image on the electrophotographic image receiving sheet, followed by smoothing the surface of the toner image comprises heating, pressurizing and then cooling the toner image and separating the electrophotographic image-receiving sheet by using an apparatus equipped with a heating and pressurizing member, a belt member and a cooling device.
